(19) United States
(12) Patent Application Publication
(10) Pub. No.: US 2025/0341396 A1
(43) Pub. Date: Nov. 6, 2025

(54) ROAD SECTION PARTITIONING

(71) Applicant: Five AI Limited, Cambridge (GB)

(72) Inventor: Marvin Alan Jones, Bristol (GB)

(73) Assignee: Five AI Limited, Cambridge (GB)

(21) Appl. No.: 18/701,143

(22) PCT Filed: Oct. 13, 2022
(86) PCT No.: PCT/EP2022/078590

§ 371 Date: Apr. 12, 2024

(30) Foreign Application Priority Data
Oct. 14, 2021 (GB) 2114684.0

(51) Int. Cl. G01C 21/32; G01C 21/00

(52) U.S. Cl. CPC G01C 21/32; G01C 21/3815; G01C 21/3867; G01C 21/3874

(57) ABSTRACT

A computer system configured to run queries on a static road layout, the computer system comprising: computer storage configured to store the static road layout, the static road layout comprising a section of road having a set of multiple road attributes, each road attribute described throughout the section of road by a describing function that exhibits a change in form at one or more change points along the section of road, the change points of a first of the road attributes exhibiting longitudinal misalignment with respect to the change points of a second of the road attributes; a road partitioning component configured to process the static road layout, and thereby partition the section of road into a sequence of road parts, each road part defined by a longitudinal coordinate interval, in which the describing function of every one of the road attributes has a form that is fixed throughout; a road indexing component configured to generate a road partition index having an entry for each road part, the entry indicating the form of the describing function of each road attribute as fixed throughout the longitudinal coordinate interval of that road part; and a scenario query engine configured to receive a part query, locate the entry in the road partition index for one of the road parts based on the part query, evaluate the describing function of at least one of the road attributes within the road part, and generate a part query response based on the evaluation of the describing function.

### TECHNICAL FIELD

The present disclosure pertains to support tools for autonomous vehicles. Such tools have offline applications to support the development and testing of autonomous vehicle systems (including simulation-based testing), as well as online applications within an autonomous vehicle system to facilitate real-time planning, prediction and/or other online functions.

### BACKGROUND

There have been major and rapid developments in the field of autonomous vehicles. An autonomous vehicle (AV) is a vehicle which is equipped with sensors and control systems which enable it to operate without a human controlling its behaviour. An autonomous vehicle is equipped with sensors which enable it to perceive its physical environment, such sensors including for example cameras, radar and lidar. Autonomous vehicles are equipped with suitably programmed computers which are capable of processing data received from the sensors and making safe and predictable decisions based on the context which has been perceived by the sensors.

An autonomous vehicle may be fully autonomous (in that it is designed to operate with no human supervision or intervention, at least in certain circumstances) or semi-autonomous.

Semi-autonomous systems require varying levels of human oversight and intervention. An Advanced Driver Assist System (ADAS) and certain levels of Autonomous Driving System (ADS) may be classed as semi-autonomous. A “level 5” vehicle is one that can operate entirely autonomously in any circumstances, because it is always guaranteed to meet some minimum level of safety. Such a vehicle would not require manual controls (steering wheel, pedals etc.) at all. By contrast, level 3 and level 4 vehicles can operate fully autonomously but only within certain defined circumstances (e.g. within geofenced areas). A level 3 vehicle must be equipped to autonomously handle any situation that requires an immediate response (such as emergency braking); however, a change in circumstances may trigger a “transition demand”, requiring a driver to take control of the vehicle within some limited timeframe. A level 4 vehicle has similar limitations; however, in the event the driver does not respond within the required timeframe, a level 4 vehicle must also be capable of autonomously implementing a “minimum risk maneuver” (MRM), i.e. some appropriate action(s) to bring the vehicle to safe conditions (e.g. slowing down and parking the vehicle). A level 2 vehicle requires the driver to be ready to intervene at any time, and it is the responsibility of the driver to intervene if the autonomous systems fail to respond properly at any time. With level 2 automation, it is the responsibility of the driver to determine when their intervention is required; for level 3 and level 4, this responsibility shifts to the vehicle's autonomous systems and it is the vehicle that must alert the driver when intervention is required.

The ability to precisely capture and describe driving scenarios is a cornerstone of autonomous vehicle technology. A typical driving scenario includes a static road layout and various dynamic agents (other vehicles, pedestrians, cyclists, animals etc.) that an autonomous vehicle (the ego vehicle) is required to navigate. An ego vehicle may be required to predict the motion of other agents and plan safely within a complex road network. In an online context, prediction and planning components require a scenario description that is sufficiently detailed and precise. In an offline context, a scenario description may be required as an input to a simulator to facilitate simulation-based testing of an autonomous vehicle stack prior to deployment on a real-world vehicle.

ASAM OpenSCENARIO® defines a file format for the description of dynamic driving scenario content. OpenSCENARIO may be used together with the ASAM OpenDRIVE® schema for describing static road networks. The stated purpose of OpenDRIVE “is to provide a road network description that can be fed into simulations to develop and validate ADAS and AD [Autonomous Driving] features” [1]. OpenDRIVE is an XML-based schema that allows road networks to be described in a hierarchical fashion. Roads are described by road elements (<road>), connectable via link elements (<link>) within the road elements. Junction elements (<junction>) are required when linking more than two roads. Every road element is characterized by a single road reference line constructed from parameterized geometric elements. OpenDRIVE denotes longitudinal and latitudinal coordinates with respect to the reference line as “s” and “t” (reference line coordinates). Lanes are described by lane elements (<lane>) within a road element. Every road element must contain a center lane element of width zero and at least one “side-lane” element of non-zero width. The center lane serves as a reference for lane numbering. By default, the center lane lies along the road reference line, but can be offset from it. For conciseness, “side-lanes” may be referred to herein simply as lanes where the meaning is unambiguous. Side-lanes may have a fixed or variable width. A side-lane may have a width of zero along a given stretch of road, but zero-width side lanes for long distances should be avoided. Road elements may be divided into sections (lane sections) to accommodate roads with changing numbers of lanes, where each lane section has a fixed number of lanes. Roads and junctions are assigned string identifiers that should be unique within a road network. Lanes are identified via incremental lane numbering relative to the center lane, and the lane numbers are only unique within a lane section. Individual lanes within two linked roads may be linked via additional link elements within the lane elements. Road/lane geometries are described in terms of functions, where the functions can change along the road (for example, a road reference line might be described as a straight line function on a given interval, followed by a spiral function, and then an arc function; a lane might be described in terms of a width function that is constant on some interval, and then changes to a linearly increasing function etc.).

In open drive, not all side-lanes are drivable. Rather “side-lane” is a broad concept to describe any road geometry. Examples of non-drivable side lines include restricted areas, pavements/sidewalks, hedgerows etc. Each side lane has configurable attributes which, among other things, indicate whether or not it is drivable.

### SUMMARY

A problem addressed herein is query efficiency on static road layouts. AV applications that benefit from speed-optimized querying of a road layout are many and varied. In an online context, a map may be queried in real time to support prediction and planning operations. In an offline context, a map might need to be queried in simulation, or at the design stage when building a dynamic layer to deploy in a simulation environment. “High definition” (HD) maps that are required in many AV contexts are particularly challenging, as such maps contain highly detailed geometric information, e.g. to centimetre precision, that needs to be processed.

Herein, a scenario query engine is supported by one or more indexes to facilitate fast, structured queries on static road layouts in online and/or offline contexts. In AV applications, the static road layout is typically represented in a highly structured format such as OpenDRIVE or other Scenario Description Language (or format, schema) etc.

A first aspect herein provides a computer system configured to run queries on a static road layout, the computer system comprising: computer storage configured to store the static road layout, the static road layout comprising a section of road having a set of multiple road attributes, each road attribute described throughout the section of road by a describing function that exhibits a change in form at one or more change points along the section of road, the change points of a first of the road attributes exhibiting longitudinal misalignment with respect to the change points of a second of the road attributes; a road partitioning component configured to process the static road layout, and thereby partition the section of road into a sequence of road parts, each road part defined by a longitudinal coordinate interval, in which the describing function of every one of the road attributes has a form that is fixed throughout; a road indexing component configured to generate a road partition index having an entry for each road part, the entry indicating the form of the describing function of each road attribute as fixed throughout the longitudinal coordinate interval of that road part; and a scenario query engine configured to receive a part query, locate the entry in the road partition index for one of the road parts based on the part query, evaluate the describing function of at least one of the road attributes within the road part, and generate a part query response based on the evaluation of the describing function.

A first of the change points in the first road attribute may cause two longitudinally adjacent road parts to be created either end of the first change point, such that the describing function of the first road attribute has one form that is fixed throughout one of the two longitudinally adjacent road parts, and a different form that is fixed throughout the other of the two longitudinally adjacent road parts. The second road attribute may have no change point that is longitudinally aligned with the first change point, causing the two longitudinally adjacent road parts to be created such that the describing function of the second road attribute has a single form throughout the two adjacent road parts. The entry for said one of the two longitudinally adjacent road parts may contain an indication of said one form of the describing function of the first road attribute, the entry for said other of the two longitudinally adjacent road parts may contain an indication of said different form of the describing function of the first road attribute, and the entries for the two longitudinally adjacent road parts may contain duplicate indications of said single form of the describing function of the second road attribute as fixed throughout both of the longitudinally adjacent road parts.

The section of road may, for example, be a lane section (in the OpenDRIVE sense). The road partition index may be built on one or multiple lane sections in this case.

Each entry of the road partition index may contain, for each road attribute, a reference to at least one memory location storing a single set of one or more function parameters that defines the form of the describing function of that road attribute as fixed throughout that road part (function reference).

The memory location could be reference directly (e.g. as a memory address) or indirectly (e.g. using some function descriptor that allows the function to be located in a specification that encodes the static road layout, or an in-memory representation of the specification).

The entries for the two longitudinally adjacent road parts may contain duplicate references to the same at least one memory location storing the single set of function parameters that define said single form of the describing function of the second road attribute.

The part query may comprise a descriptor of the road part to which it pertains, which may be used to locate the entry for that road part by matching the descriptor to the road part.

The descriptor in the part query may comprise the longitudinal coordinate interval of the road part to which it pertains or a longitudinal coordinate within the longitudinal coordinate interval.

The multiple road attributes may comprise at least one road geometry attribute (such as the geometry of a particular road or lane border).

The part query may provide a set of world coordinates, and the scenario query engine may be configured to evaluate the describing function of the at least one road geometry attribute in order to determine a corresponding set of road coordinates provided in the part query response.

The part query may provide a location and the scenario query engine may be configured to evaluate the describing function of the at least one road geometry attribute in order to determine a corresponding location in the section of road having a predetermined geometric relationship to the provided location, the part query response providing the corresponding location.

The section of road may have multiple lanes, and the multiple road attributes may comprise multiple lane attributes (such as lane border or characteristics thereof).

The descriptor in the part query may be a descriptor of a lane part that is defined by the road part and a lane identifier of one of the multiple lanes.

The at least one road geometry attribute may comprise at least one lane geometry attribute of the multiple lane attributes.

The at least one lane geometry attribute may comprise a lane geometry attribute of the identified lane.

The part query may provide a location, and the scenario query engine may be configured to evaluate the lane geometry attribute of the identified lane in order to determine a corresponding location in the lane having a predetermined geometric relationship to the provided location, the part query response providing the corresponding location.

The corresponding location may be a closest location to the provided location on a midline of the identified lane.

The computer system may comprise a spatial indexing component configured to compute individual geometric elements of the static road layout, and create at least one spatial index of the individual geometric elements, wherein every individual geometric element is fully contained within a single road part. The scenario query engine may be configured to receive a spatial query and use the spatial index to generate a spatial query response.

The spatial indexing component may be configured to use the road partition index to generate the spatial index, said part query being, in that event, an internal part query from the geometric indexing component for computing one or more of the individual geometric elements contained within the road part.

The spatial index may contain, for each individual geometric element, geometric data of the individual geometric element and an indication of the single road part for locating the entry for the single road part in the road partition index. The spatial query response may comprise a descriptor of at least one road part satisfying the spatial query for locating the entry for that road part in the road partition index.

The scenario query engine may be configured to receive a further part query comprising a descriptor of a road part, locate the entry for that road part in the road partition index, evaluate the describing function of at least one of the road attributes within that road part, and generate a further part query response based on the evaluation of that describing function.

The or each descriptor may comprise a lane identifier, and thus describe a lane part defined by the road part and the lane identifier.

The spatial query may provide a location, and the geometric condition may be satisfied by any road part or lane part having a predetermined geometric relationship to the provided location.

The road section may comprise multiple lanes, and each individual geometric element may be a lane part, the lane part being one of the multiple lanes contained within the single road part or a portion of one of the multiple lanes contained with the single road part.

The spatial index may comprise a bounding box index storing, for each lane part, a lane part bounding box, a lane identifier, and an indication of the single road part for locating the entry for the single road part in the road partition index.

The spatial query may be a containment query providing a location, and the scenario query engine is configured to process the containment query by: identifying any lane part whose lane part bounding box in the bounding box index contains the location; using the indication of the single road part for any identified lane to locate the entry for that road part in the road partition index, using the describing function for at least one of the road attributes to compute a lane geometry for the lane identifier, and determining whether the provided location is contained within the lane geometry.

The spatial query may provide a required lane type, and said identifying may be restricted to lane parts of the required lane type.

The road section may comprise multiple lanes, and each individual geometric element may be a line segment of a lane border that is fully contained within the single road part. The spatial index may comprise one or more line segment indexes storing each line segment with a lane identifier, and an indication of the single road part for locating the entry for the single road part in the road partition index, and any line segment of a lane border between two lanes may be stored twice with different lane identifiers.

The spatial query may be a distance query providing a location and a required lane type.

The scenario query engine may be configured to process the distance query by identifying a closest one of the line segments to the provided location that matches the required lane type.

The spatial index may comprise an inner boundary line segment index and an outer boundary line segment index, and any line segment of a lane border between two lanes may be stored in the inner boundary line segment with a lane identifier of one of those two lanes, and in the outer boundary line segment tree with a lane identifier of the other of those two lanes

The static road layout may have multiple sections of road, with different numbers of road attributes, and the road partitioning component may be configured to partition the multiple sections of road into said sequence of road parts. The longitudinal coordinate interval of each road part may be such that the number of road attributes does not change and the describing function of every one of the road attributes has a form that is fixed throughout.

The single set of one or more function parameters may be stored in an in-memory representation of a specification containing the static road layout that is referenced by the road partition index.

The speciation may conform to a structured scenario description format.

A second aspect herein provides a road partition index of a static road layout, the road partition index held in memory of a computer system for running queries on the static road layout, the static road layout comprising a section of road having a set of multiple road attributes, each road attribute described throughout the section of road by a describing function that exhibits a change in form at one or more change points along the section of road, the change points of a first of the road attributes exhibiting longitudinal misalignment with respect to the change points of a second of the road attributes, the road partition index comprising: an entry for each road part of a sequence of road parts, each road part defined by a longitudinal coordinate interval, in which the describing function of every one of the road attributes has a form that is fixed throughout, the entry indicating the form of the describing function of each road attribute as fixed throughout the longitudinal coordinate interval of that road part.

Further aspects provide a computer system comprising one or more computers configured to implement any of the method steps/system functionality disclosed herein, and executable program instructions for programming a computer system to implement the same.

### BRIEF DESCRIPTION OF FIGURES

For a better understanding of the present disclosure, and to show how embodiments of the same may be carried into effect, reference is made by way of example only to the following figures in which:

FIG. 1A shows a schematic function block diagram of an autonomous vehicle stack;

FIG. 1B shows a schematic overview of an autonomous vehicle testing paradigm;

FIG. 1C shows a schematic block diagram of a scenario extraction pipeline;

FIG. 2 shows a schematic block diagram of a testing pipeline;

FIG. 3A shows a schematic block diagram of a visualization component for rendering a graphical user interface on which test results are displayed;

FIG. 3B shows a view available within a graphical user interface;

FIG. 4 shows a schematic block diagram of a scenario access system;

FIG. 4A shows an example a set of spatial indexes supporting a scenario query engine;

FIG. 5 shows an example road network;

FIG. 6 shows part of a road network annotated with OpenDRIVE elements used to describe the road network;

FIG. 7 shows an in-memory lane graph extracted from a static road layout;

FIG. 7A shows part of a lane graph with associated edge costs;

FIG. 8 shows a lane graph for a road network that includes a bidirectional lane;

FIG. 9 shows a road and a road partition index constructed on the road;

FIG. 10A shows part of a line segment tree containing inner lane boundary line segments;

FIG. 10B shows bounding boxes and inner boundary line segments contained at different levels in a line segment tree;

FIG. 10C shows an expanded view of some of the inner boundary line segments of FIG. 10B;

FIG. 10D shows part of a line segment tree containing outer lane boundary line segments;

FIG. 10E shows bounding boxes and outer boundary line segments contained at different levels in a line segment tree;

FIG. 10F shows an expanded view of some of the outer boundary line segments of FIG. 10E;

FIG. 11A shows part of an example bounding box tree;

FIG. 11B shows bounding boxes stored at different levels in a bounding box tree;

FIG. 11C shows an expanded view of some of the boxes stored in the lowest level of the tree of FIG. 11B;

FIG. 12 shows details of a geometric indexing component supported by a road partition index;

FIG. 13 shows a flow chart for the processing of a containment query;

FIG. 14A shows a flow diagram for the processing of a track coordinates query;

FIG. 14B shows a flow diagram for the processing of a query to find the point on a lane midline closest to a given (x,y) point;

FIG. 15A shows a flow chart for the processing of a distance query;

FIG. 15B illustrates how an outer lane boundary line segment tree may be used to find the lane of unspecified type closest to a given point; and

FIG. 15C illustrates how inner and outer lane boundary line segment trees may be used to find the lane of a specified type closest to a given point;

### DETAILED DESCRIPTION

A scenario query engine (SQE) is described, which allows efficient geometric and topological querying of a static road layout. The static road layout may for example be formulated in OpenDRIVE or some other schema. Both geometric and topological queries return results in a form that can be interpreted in the context of the original road layout description. OpenDRIVE is intended to be mainly optimized for processing “on the wire”. To a degree, the schema seeks to avoid duplication of information (although this is by no means a hard-and-fast rule). All-in-all, the construction of the OpenDRIVE schema is not well-suited to certain forms of querying, rendering certain applications of OpenDRIVE seemingly impractical. The SQE addresses these issues as described below, which opens up new practical applications of OpenDRIVE and similar schemas.

The described techniques have both “online” and “offline” applications in autonomous driving.

An online (or “runtime”) application refers to an implementation within an autonomous vehicle stack to support autonomous planning or other decision-making functions (such as motion planning, motion prediction, route planning etc.). In an online context, a planner is required to plan driving actions for a given scenario, responding to changes in the scenario in real-time.

An offline application refers to other forms of applications, for example as part of a set of tools to support the development, testing and/or training of AV systems. By way of example, a testing pipeline is described below for assessing driving performance in real or simulated scenarios. Performance can include different facets of safety, comfort or progress towards some defined goal.

Whether real or simulated, a scenario requires an ego agent to navigate a real or modelled physical context. The ego agent is a real or simulated mobile robot that moves under the control of the stack under testing. The physical context includes static and/or dynamic element(s) that the stack under testing is required to respond to effectively. For example, the mobile robot may be a fully or semi-autonomous vehicle under the control of the stack (the ego vehicle). The physical context may comprise a static road layout and a given set of environmental conditions (e.g. weather, time of day, lighting conditions, humidity, pollution/particulate level etc.) that could be maintained or varied as the scenario progresses. A dynamic scenario additionally includes one or more other agents (“external” agent(s), e.g. other vehicles, pedestrians, cyclists, animals etc.).

In an offline simulation context, a scenario description is provided to an offline simulator as input, in order to expose a stack under testing to a simulated scenario. In an online context, a perception system may be used to generate a scenario description that can be used as a basis for higher-level functions, such as motion prediction and planning, which might involve some form of online simulation to simulate possible futures and plan accordingly.

A scenario description may be encoded using a scenario description language (SDL), or in any other form that can be consumed by whichever component(s) require it. As briefly discussed, the ASAM OpenDRIVE® standard defines a storage format for the static description of road networks and OpenSCENARIO® may be used to add dynamic content.

Other forms of scenario description may be used, including bespoke languages and formats, and the present techniques are not limited to any particular SDL, storage format, schema or standard.

A “scenario run” or “scenario instance” refers to a concrete occurrence of an agent(s) navigating a physical context, optionally in the presence of one or more other agents. A single scenario description can give rise to multiple simulated runs, with different outcomes, not least because those outcomes depend on decisions taken by the stack under testing. The terms “run” and “instance” are used interchangeably in this context.

### Example AV Stack

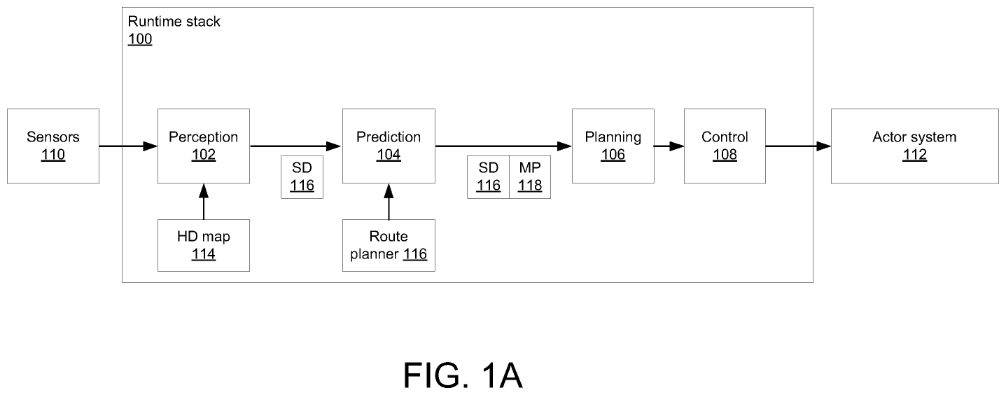

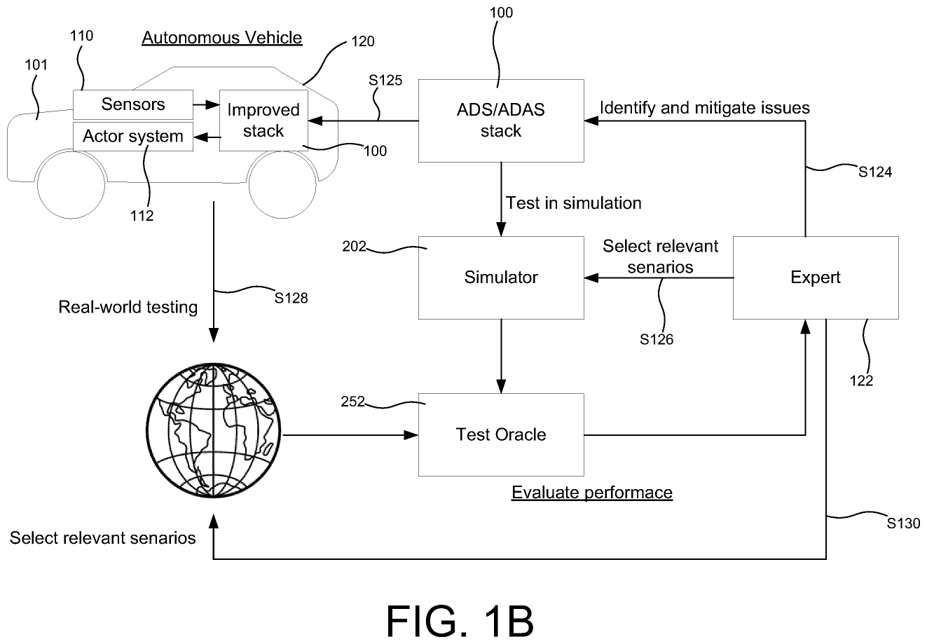

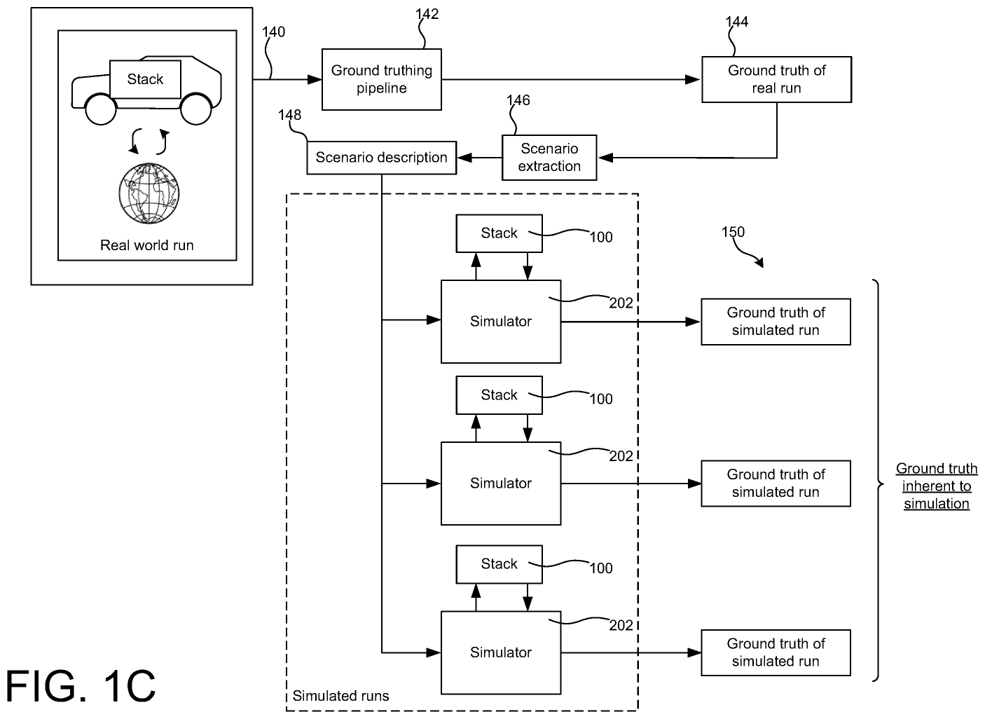

FIG. 1A shows a highly schematic block diagram of an AV runtime stack 100. The stack 100 may be fully or semi-autonomous. For example, the stack 100 may operate as an Autonomous Driving System (ADS) or Advanced Driver Assist System (ADAS).

The run time stack 100 is shown to comprise a perception (sub-)system 102, a prediction (sub-)system 104, a planning (sub-)system (planner) 106 and a control (sub-)system (controller) 108.

In a real-world context, the perception system 102 receives sensor outputs from an on-board sensor system 110 of the AV, and uses those sensor outputs to detect external agents and measure their physical state, such as their position, velocity, acceleration etc. The on-board sensor system 110 can take different forms but generally comprises a variety of sensors such as image capture devices (cameras/optical sensors), lidar and/or radar unit(s), satellite-positioning sensor(s) (GPS etc.), motion/inertial sensor(s) (accelerometers, gyroscopes etc.) etc. The onboard sensor system 110 thus provides rich sensor data from which it is possible to extract detailed information about the surrounding environment, and the state of the AV and any external actors (vehicles, pedestrians, cyclists etc.) within that environment. The sensor outputs typically comprise sensor data of multiple sensor modalities such as stereo images from one or more stereo optical sensors, lidar, radar etc. Sensor data of multiple sensor modalities may be combined using filters, fusion components etc.

The perception system 102 typically comprises multiple perception components which co-operate to interpret the sensor outputs and thereby provide perception outputs to the prediction system 104.

In a simulation context, depending on the nature of the testing—and depending, in particular, on where the stack 100 is “sliced” for the purpose of testing (see below)—it may or may not be necessary to model the on-board sensor system 100. With higher-level slicing, simulated sensor data is not required therefore complex sensor modelling is not required.

The perception outputs from the perception system 102 are used by the prediction system 104 to predict future behaviour of external actors (agents), such as other vehicles in the vicinity of the AV.

Predictions computed by the prediction system 104 are provided to the planner 106, which uses the predictions to make autonomous driving decisions to be executed by the AV in a given driving scenario. The inputs received by the planner 106 would typically indicate a drivable area and would also capture predicted movements of any external agents (obstacles, from the AV's perspective) within the drivable area. The driveable area can be determined using perception outputs from the perception system 102 in combination with map information, such as an HD (high definition) map.

A core function of the planner 106 is the planning of trajectories for the AV (ego trajectories), taking into account predicted agent motion. This may be referred to as trajectory planning. A trajectory is planned in order to carry out a desired goal within a scenario. The goal could for example be to enter a roundabout and leave it at a desired exit; to overtake a vehicle in front; or to stay in a current lane at a target speed (lane following). The goal may, for example, be determined by an autonomous route planner 116, also referred to as a goal generator 116.

The controller 108 executes the decisions taken by the planner 106 by providing suitable control signals to an on-board actor system 112 of the AV. In particular, the planner 106 plans trajectories for the AV and the controller 108 generates control signals to implement the planned trajectories. Typically, the planner 106 will plan into the future, such that a planned trajectory may only be partially implemented at the control level before a new trajectory is planned by the planner 106. The actor system 112 includes “primary” vehicle systems, such as braking, acceleration and steering systems, as well as secondary systems (e.g. signalling, wipers, headlights etc.).

The example of FIG. 1A considers a relatively “modular” architecture, with separable perception, prediction, planning and control systems 102-108. The sub-stack themselves may also be modular, e.g. with separable planning modules within the planning system 106. For example, the planning system 106 may comprise multiple trajectory planning modules that can be applied in different physical contexts (e.g. simple lane driving vs. complex junctions or roundabouts). This is relevant to simulation testing for the reasons noted above, as it allows components (such as the planning system 106 or individual planning modules thereof) to be tested individually or in different combinations. For the avoidance of doubt, with modular stack architectures, the term stack can refer not only to the full stack but to any individual sub-system or module thereof.

The extent to which the various stack functions are integrated or separable can vary significantly between different stack implementations—in some stacks, certain aspects may be so tightly coupled as to be indistinguishable. For example, in other stacks, planning and control may be integrated (e.g. such stacks could plan in terms of control signals directly), whereas other stacks (such as that depicted in FIG. 1A) may be architected in a way that draws a clear distinction between the two (e.g. with planning in terms of trajectories, and with separate control optimizations to determine how best to execute a planned trajectory at the control signal level). Similarly, in some stacks, prediction and planning may be more tightly coupled. At the extreme, in so-called “end-to-end” driving, perception, prediction, planning and control may be essentially inseparable. Unless otherwise indicated, the perception, prediction planning and control terminology used herein does not imply any particular coupling or modularity of those aspects.

A “full” stack typically involves everything from processing and interpretation of low-level sensor data (perception), feeding into primary higher-level functions such as prediction and planning, as well as control logic to generate suitable control signals to implement planning-level decisions (e.g. to control braking, steering, acceleration etc.). For autonomous vehicles, level 3 stacks include some logic to implement transition demands and level 4 stacks additionally include some logic for implementing minimum risk maneuvers. The stack may also implement secondary control functions e.g. of signalling, headlights, windscreen wipers etc.

The term “stack” can also refer to individual sub-systems (sub-stacks) of the full stack, such as perception, prediction, planning or control stacks 104, 106, 108, which may be tested individually or in any desired combination. A stack can refer purely to software, i.e. one or more computer programs that can be executed on one or more general-purpose computer processors. It will be appreciated that the term “stack” encompasses software, but can also encompass hardware. In simulation, software of the stack may be tested on a “generic” off-board computer system, before it is eventually uploaded to an on-board computer system of a physical vehicle. However, in “hardware-in-the-loop” testing, the testing may extend to underlying hardware of the vehicle itself. For example, the stack software may be run on the on-board computer system (or a replica thereof) that is coupled to the simulator for the purpose of testing. In this context, the stack under testing extends to the underlying computer hardware of the vehicle. As another example, certain functions of the stack 110 (e.g. perception functions) may be implemented in dedicated hardware. In a simulation context, hardware-in-the loop testing could involve feeding synthetic sensor data to dedicated hardware perception components.

Within the stack 100, a scenario description 116 may be used as a basis for planning and prediction. The scenario description 116 is generated using the perception system 102, together with a high-definition (HD) map 114. By localizing the ego vehicle 114 on the map, it is possible to combine the information extracted in the perception system 104 (including dynamic agent information) with the pre-existing environmental information contained in the HD map 114. The scenario description 116 is, in turn, used as a basis for motion prediction in the prediction system 104, and the resulting motion predictions 118 are used in combination with the scenario description 116 as a basis for planning in the planning system 106.

### Example Testing Paradigm

FIG. 1B shows a highly schematic overview of a testing paradigm for autonomous vehicles. An ADS/ADAS stack 100, e.g. of the kind depicted in FIG. 1A, is subject to repeated testing and evaluation in simulation, by running multiple scenario instances in a simulator 202, and evaluating the performance of the stack 100 (and/or individual subs-stacks thereof) in a test oracle 252. The output of the test oracle 252 is informative to an expert 122 (team or individual), allowing them to identify issues in the stack 100 and modify the stack 100 to mitigate those issues (S124). The results also assist the expert 122 in selecting further scenarios for testing (S126), and the process continues, repeatedly modifying, testing and evaluating the performance of the stack 100 in simulation. The improved stack 100 is eventually incorporated (S125) in a real-world AV 101, equipped with a sensor system 110 and an actor system 112. The improved stack 100 typically includes program instructions (software) executed in one or more computer processors of an on-board computer system of the vehicle 101 (not shown). The software of the improved stack is uploaded to the AV 101 at step S125. Step S125 may also involve modifications to the underlying vehicle hardware. On board the AV 101, the improved stack 100 receives sensor data from the sensor system 110 and outputs control signals to the actor system 112. Real-world testing (S128) can be used in combination with simulation-based testing. For example, having reached an acceptable level of performance through the process of simulation testing and stack refinement, appropriate real-world scenarios may be selected (S130), and the performance of the AV 101 in those real scenarios may be captured and similarly evaluated in the test oracle 252.

Scenarios can be obtained for the purpose of simulation in various ways, including manual encoding. The system is also capable of extracting scenarios for the purpose of simulation from real-world runs, allowing real-world situations and variations thereof to be re-created in the simulator 202.

FIG. 1C shows a highly schematic block diagram of a scenario extraction pipeline. Data 140 of a real-world run is passed to a ‘ground-truthing’ pipeline 142 for the purpose of generating scenario ground truth. The run data 140 could comprise, for example, sensor data and/or perception outputs captured/generated on board one or more vehicles (which could be autonomous, human-driven or a combination thereof), and/or data captured from other sources such external sensors (CCTV etc.). The run data is processed within the ground truthing pipeline 142, in order to generate appropriate ground truth 144 (“trace(s)” and contextual data) for the real-world run. The ground-truthing process could be based on manual annotation of the ‘raw’ run data 140, or the process could be entirely automated (e.g. using offline perception method(s)), or a combination of manual and automated ground truthing could be used. For example, 3D bounding boxes may be placed around vehicles and/or other agents captured in the run data 140, in order to determine spatial and motion states of their traces. A scenario extraction component 146 receives the scenario ground truth 144, and processes the scenario ground truth 144 to extract a scenario description 148 that can be used for the purpose of simulation. The scenario description 148 is consumed by the simulator 202, allowing multiple simulated runs to be derived therefrom. Ground truth 150 is provided for each simulated run.

A “trace” is a history of an agent's location and motion over the course of a scenario. There are many ways a trace can be represented. Trace data will typically include spatial and motion data of an agent within the environment. The term is used in relation to both real scenarios (with real-world traces) and simulated scenarios (with simulated traces).

The term “perception” generally refers to techniques for perceiving structure in the real-world data 140, such as 2D or 3D bounding box detection, location detection, pose detection, motion detection etc. For example, a trace may be extracted as a time-series of bounding boxes or other spatial states in 3D space or 2D space (e.g. in a birds-eye-view frame of reference), with associated motion information (e.g. speed, acceleration, jerk etc.). In the context of image processing, such techniques are often classed as “computer vision”, but the term perception encompasses a broader range of sensor modalities.

### Testing Pipeline

Further details of an example testing pipeline incorporating the test oracle 252 will now be described. The examples that follow focus on simulation-based testing. However, as noted, the test oracle 252 can equally be applied to evaluate stack performance on real scenarios, and the relevant description below applies equally to real scenarios. The following description refers to the stack 100 of FIG. 1A by way of example. However, as noted, the testing pipeline 200 is highly flexible and can be applied to any stack or sub-stack operating at any level of autonomy.

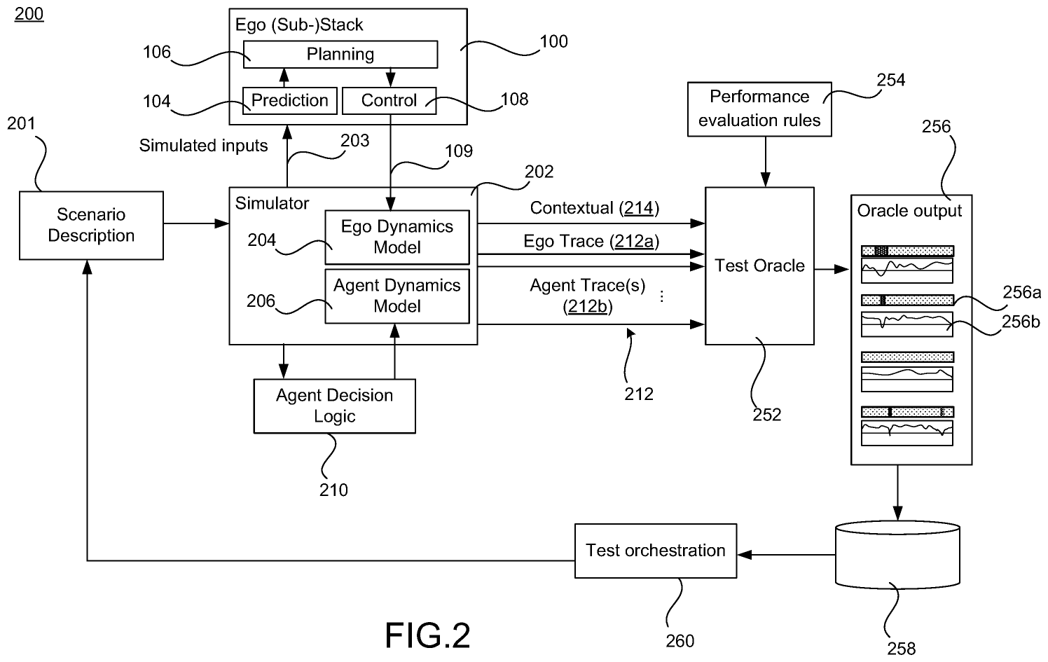

FIG. 2 shows a schematic block diagram of the testing pipeline, denoted by reference numeral 200. The testing pipeline 200 is shown to comprise the simulator 202 and the test oracle 252. The simulator 202 runs simulated scenarios for the purpose of testing all or part of an AV run time stack 100, and the test oracle 252 evaluates the performance of the stack (or sub-stack) on the simulated scenarios. As discussed, it may be that only a sub-stack of the run-time stack is tested, but for simplicity, the following description refers to the (full) AV stack 100 throughout. However, the description applies equally to a sub-stack in place of the full stack 100. The term “slicing” is used herein to the selection of a set or subset of stack components for testing.

The idea of simulation-based testing is to run a simulated driving scenario that an ego agent must navigate under the control of the stack 100 being tested. Typically, the scenario includes a static drivable area (e.g. a particular static road layout) that the ego agent is required to navigate, typically in the presence of one or more other dynamic agents (such as other vehicles, bicycles, pedestrians etc.). To this end, simulated inputs 203 are provided from the simulator 202 to the stack 100 under testing.

The slicing of the stack dictates the form of the simulated inputs 203. By way of example, FIG. 2 shows the prediction, planning and control systems 104, 106 and 108 within the AV stack 100 being tested. To test the full AV stack of FIG. 1A, the perception system 102 could also be applied during testing. In this case, the simulated inputs 203 would comprise synthetic sensor data that is generated using appropriate sensor model(s) and processed within the perception system 102 in the same way as real sensor data. This requires the generation of sufficiently realistic synthetic sensor inputs (such as photorealistic image data and/or equally realistic simulated lidar/radar data etc.). The resulting outputs of the perception system 102 would, in turn, feed into the higher-level prediction and planning systems 104, 106.

By contrast, so-called “planning-level” simulation would essentially bypass the perception system 102. The simulator 202 would instead provide simpler, higher-level inputs 203 directly to the prediction system 104. In some contexts, it may even be appropriate to bypass the prediction system 104 as well, in order to test the planner 106 on predictions obtained directly from the simulated scenario (i.e. “perfect” predictions).

Between these extremes, there is scope for many different levels of input slicing, e.g. testing only a subset of the perception system 102, such as “later” (higher-level) perception components, e.g. components such as filters or fusion components which operate on the outputs from lower-level perception components (such as object detectors, bounding box detectors, motion detectors etc.).

As an alternative to synthetic sensor data, all or part of the perception system 102 may be modelled, e.g. using one or more perception error models to introduce realistic error into the simulated inputs 203. For example, Perception Statistical Performance Models (PSPMs) or, synonymously, “PRISMs” may be used. Further details of the principles of PSPMs, and suitable techniques for building and training such models, may be bound in International Patent Publication Nos. WO2021037763 WO2021037760, WO2021037765, WO2021037761, and WO2021037766, each of which is incorporated herein by reference in its entirety.

Whatever form they take, the simulated inputs 203 are used (directly or indirectly) as a basis for decision-making by the planner 108. The controller 108, in turn, implements the planner's decisions by outputting control signals 109. In a real-world context, these control signals would drive the physical actor system 112 of AV. In simulation, an ego vehicle dynamics model 204 is used to translate the resulting control signals 109 into realistic motion of the ego agent within the simulation, thereby simulating the physical response of an autonomous vehicle to the control signals 109.

Alternatively, a simpler form of simulation assumes that the ego agent follows each planned trajectory exactly between planning steps. This approach bypasses the control system 108 (to the extent it is separable from planning) and removes the need for the ego vehicle dynamic model 204. This may be sufficient for testing certain facets of planning.

To the extent that external agents exhibit autonomous behaviour/decision making within the simulator 202, some form of agent decision logic 210 is implemented to carry out those decisions and determine agent behaviour within the scenario. The agent decision logic 210 may be comparable in complexity to the ego stack 100 itself or it may have a more limited decision-making capability. The aim is to provide sufficiently realistic external agent behaviour within the simulator 202 to be able to usefully test the decision-making capabilities of the ego stack 100. In some contexts, this does not require any agent decision making logic 210 at all (open-loop simulation), and in other contexts useful testing can be provided using relatively limited agent logic 210 such as basic adaptive cruise control (ACC). One or more agent dynamics models 206 may be used to provide more realistic agent behaviour if appropriate.

A scenario is run in accordance with a scenario description 201, which typically has both static and dynamic elements. The static element(s) typically include a static road layout. The dynamic element(s) typically include one or more external agents within the scenario, such as other vehicles, pedestrians, bicycles etc. Scenario runs are orchestrated by a test orchestration component 260.

The extent of the dynamic information provided to the simulator 202 for each external agent can vary. For example, a scenario may be described by separable static and dynamic layers. A given static layer (e.g. defining a road layout) can be used in combination with different dynamic layers to provide different scenario instances. The dynamic layer may comprise, for each external agent, a spatial path to be followed by the agent together with one or both of motion data and behaviour data associated with the path. In simple open-loop simulation, an external actor simply follows the spatial path and motion data defined in the dynamic layer that is non-reactive i.e. does not react to the ego agent within the simulation. Such open-loop simulation can be implemented without any agent decision logic 210. However, in closed-loop simulation, the dynamic layer instead defines at least one behaviour to be followed along a static path (such as an ACC behaviour). In this case, the agent decision logic 210 implements that behaviour within the simulation in a reactive manner, i.e. reactive to the ego agent and/or other external agent(s). Motion data may still be associated with the static path but in this case is less prescriptive and may for example serve as a target along the path. For example, with an ACC behaviour, target speeds may be set along the path which the agent will seek to match, but the agent decision logic 210 might be permitted to reduce the speed of the external agent below the target at any point along the path in order to maintain a target headway from a forward vehicle.

The output of the simulator 202 for a given simulation includes an ego trace 212a of the ego agent and one or more agent traces 212b of the one or more external agents (traces 212). Each trace 212a, 212b is a complete history of an agent's behaviour within a simulation having both spatial and motion components. For example, each trace 212a, 212b may take the form of a spatial path having motion data associated with points along the path such as speed, acceleration, jerk (rate of change of acceleration), snap (rate of change of jerk) etc.

Additional information is also provided to supplement and provide context to the traces 212. Such additional information is referred to as “contextual” data 214. The contextual data 214 pertains to the physical context of the scenario, and can have both static components (such as road layout) and dynamic components (such as weather conditions to the extent they vary over the course of the simulation).

The test oracle 252 receives the traces 212 and the contextual data 214, and scores those outputs in respect of a set of performance evaluation rules 254. The performance evaluation rules 254 are shown to be provided as an input to the test oracle 252.

The rules 254 are categorical in nature (e.g. pass/fail-type rules). Certain performance evaluation rules are also associated with numerical performance metrics used to “score” trajectories (e.g. indicating a degree of success or failure or some other quantity that helps explain or is otherwise relevant to the categorical results). The evaluation of the rules 254 is time-based—a given rule may have a different outcome at different points in the scenario. The scoring is also time-based: for each performance evaluation metric, the test oracle 252 tracks how the value of that metric (the score) changes over time as the simulation progresses. The test oracle 252 provides an output 256 comprising a time sequence 256a of categorical (e.g. pass/fail) results for each rule, and a score-time plot 256b for each performance metric, as described in further detail later. The results and scores 256a, 256b are informative to the expert 122 and can be used to identify and mitigate performance issues within the tested stack 100. The test oracle 252 also provides an overall (aggregate) result for the scenario (e.g. overall pass/fail). The output 256 of the test oracle 252 is stored in a test database 258, in association with information about the scenario to which the output 256 pertains.

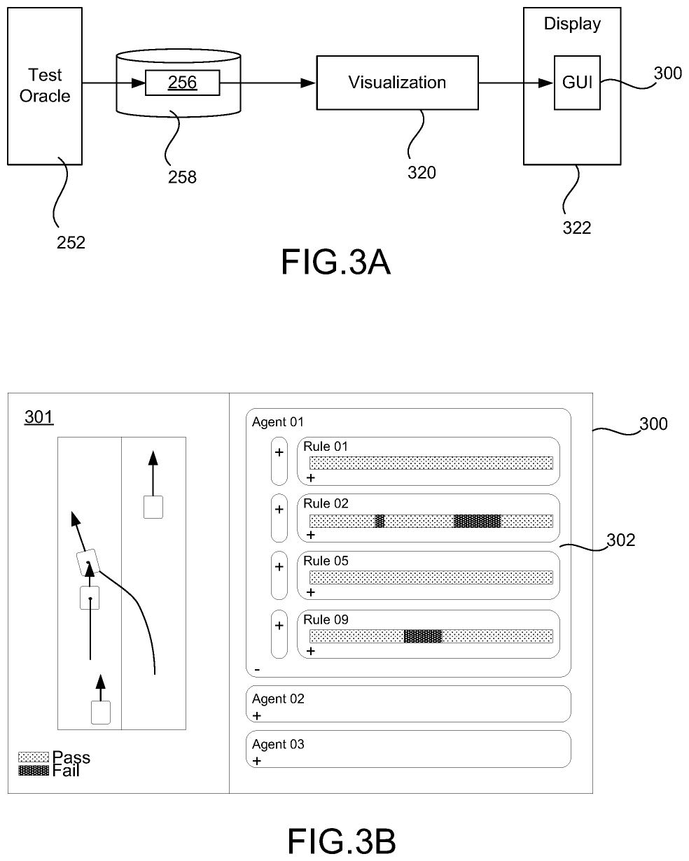

FIG. 3A shows a schematic block diagram of a visualization component 320. The visualization component 320 is shown having an input connected to the test database 258 for rendering the outputs 256 of the test oracle 252 on a graphical user interface (GUI) 300. The GUI is rendered on a display system 322.

FIG. 3B shows an example view of the GUI 300. The view pertains to a particular scenario containing multiple agents, and is shown to comprise a scenario visualization 301 and a set of driving performance assessment results 302. In this example, the test oracle output 526 pertains to multiple external agents, and the results are organized according to agent. For each agent, a time-series of results is available for each rule applicable to that agent at some point in the scenario. Colour coding is used to differentiate between periods of pass/fail on a particular rule.

### Scenario Query Engine

The scenario descriptions 116, 148, 201 described above are typically highly detailed. A high level of precision is required of the 3D road and lane geometry, typically to centimetre precision. A complex driving scenario might involve a network of roads and junction(s). It is often inefficient and time consuming to extract a required piece of information from a scenario description directly. To this end, a scenario query engine is provided, which allows fast processing of structured queries to be performed on a driving scenario description. The scenario query engine has many applications, including online applications of the kind depicted in FIG. 1A and offline applications of the kind depicted in FIGS. 1C and 2.

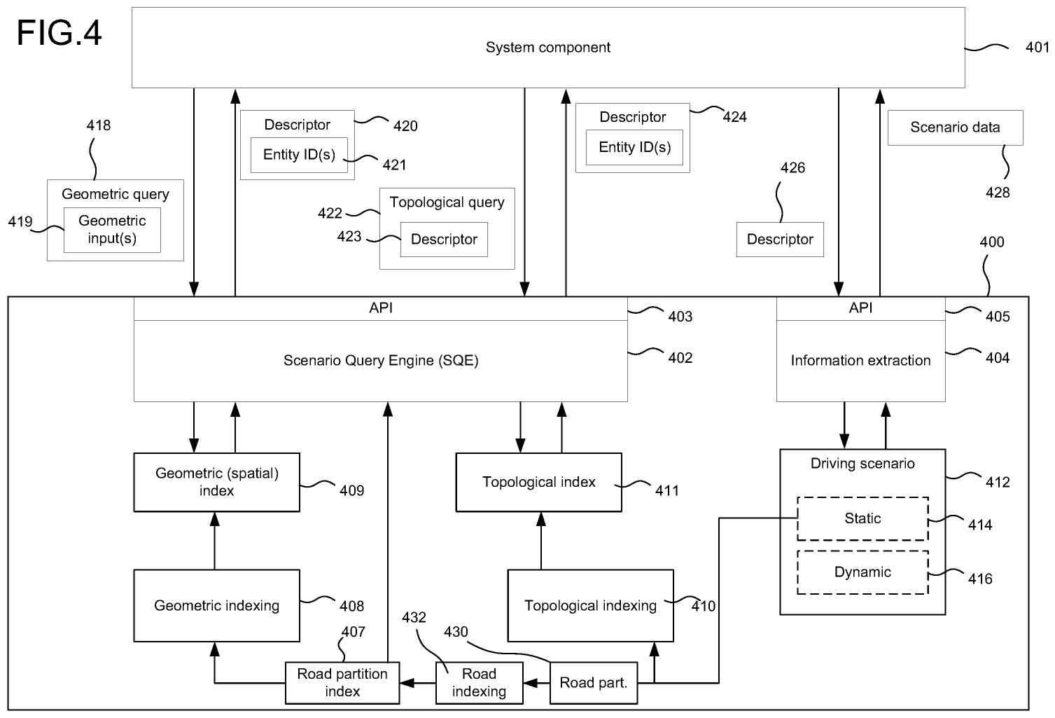

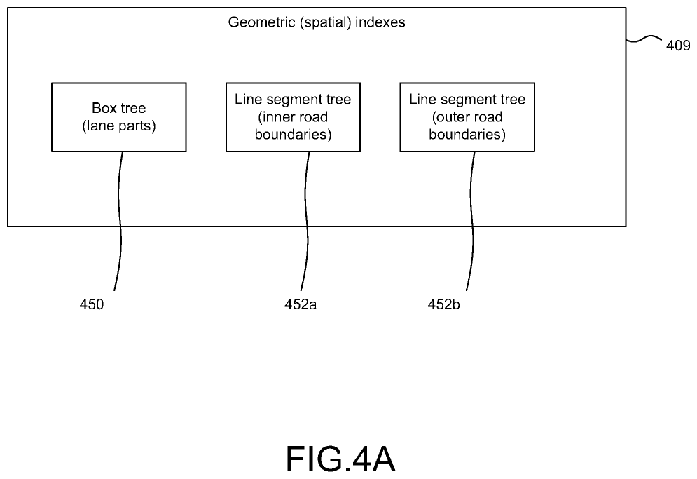

FIG. 4 shows a schematic block diagram of a scenario access system 400. The scenario access system 400 provides optimized information retrieval on behalf of other system components that require access to a driving scenario description 412.

The scenario description 412 is shown to have both static and dynamic layers 414, 416. In this example, the static layer 414 is encoded in a specification (document) that conforms to the OpenDRIVE schema, or some variant of OpenDRIVE (or other structured scenario description format), and the dynamic layer 416 is encoded using OpenSCENARIO.

The scenario access system is shown to comprise a scenario query engine (SQE) 402 and an extraction component 404. The SQE 402 is called via a first application programming interface (403) and the information extraction component 404 is called via a second API 405.

The first API 403 provides a set of scenario query functions that can be flexibly combined to perform complex queries on the driving scenario 412, and the second API 405 provides a set of information extraction functions for selectively extracting information from the driving scenario 412. A system component 401 built on top of the APIs 403, 405 is depicted. Different system components can be built on the APIs 403, 405 in this manner, reducing the burden on software developers. The system component 401 could, for example, be a component of the online stack 100 (such as the planning or prediction system 104, 106, or some component thereof) or an offline component (such as the simulator 202 within the testing pipeline 200).

The SQE 402 accepts both “geometric” and “topological” queries on the scenario description 412. Various scenario query functions provide results in the form of “descriptors” that allow information to be located in the underlying scenario description 412. The following examples consider geometric and topological queries on the static layer 414.

A geometric query 418 indicates one or more geometric constraints 419 (geometric inputs), and returns a response 420 in the form of a descriptor that identifies one or more road structure elements that satisfy the geometric constraints 419.

A descriptor comprises an identifier of each road structure entity that allows the corresponding section of the static layer 412 (that is, the section describing that road structure element) to be located (denoted by reference numeral 421 for the descriptor 420). A descriptor may contain additional information about the road structure element(s) satisfying the query. For example, the geometric inputs 419 might define a point or box (rectangle), and the response might indicate any road structure element(s) that intersect that point or box.

To facilitate geometric queries, a geometric indexing component 408 is provided. The geometric indexing component 408 builds a geometric (spatial) index 409 of the static layer 414 of the scenario description 412. The geometric index 409 is an in-memory data structure that maps geometric inputs to corresponding road structure elements within the scenario description 412. In the following examples, “roads” and “lanes” are the main types of road element considered. As described in further detail below, in OpenDRIVE, roads are described in terms of <road> elements and lanes are described in terms of <lane> elements. Although a single geometric index 409 is depicted, separate geometric indexes may be provided for different types of road structure element, for example separate spatial indexes for road and lanes.

To support efficient geometric querying, novel “road part” and “lane part” concepts are introduced. These concepts and their manner of utilization are described in Table 1 below.

The geometric index 409 is two-dimensional (2D), defined in a birds-eye-view plane of the road network. The static layer 414 may be 3D (e.g. to describe varying road elevation), even when the geometric index 409 is 2D. In other implementations, the geometric index 409 is three dimensional. Three-dimensional spatial indices may be useful e.g. in addressing ambiguity inherent in a plan view associated with under/over passes (where one road passes under another, leading to ambiguity in a 2D plan view).

Whilst the geometric index 409 is depicted as a single element in FIG. 4, in the described implementations, the API 403 is supported by a collection of geometric indexes.

FIG. 4A shows multiple geometric indexes, namely a bounding box tree 450, an inner boundary line segment tree 452a and an outer boundary line segment tree 452b, each of which is described in detail below.

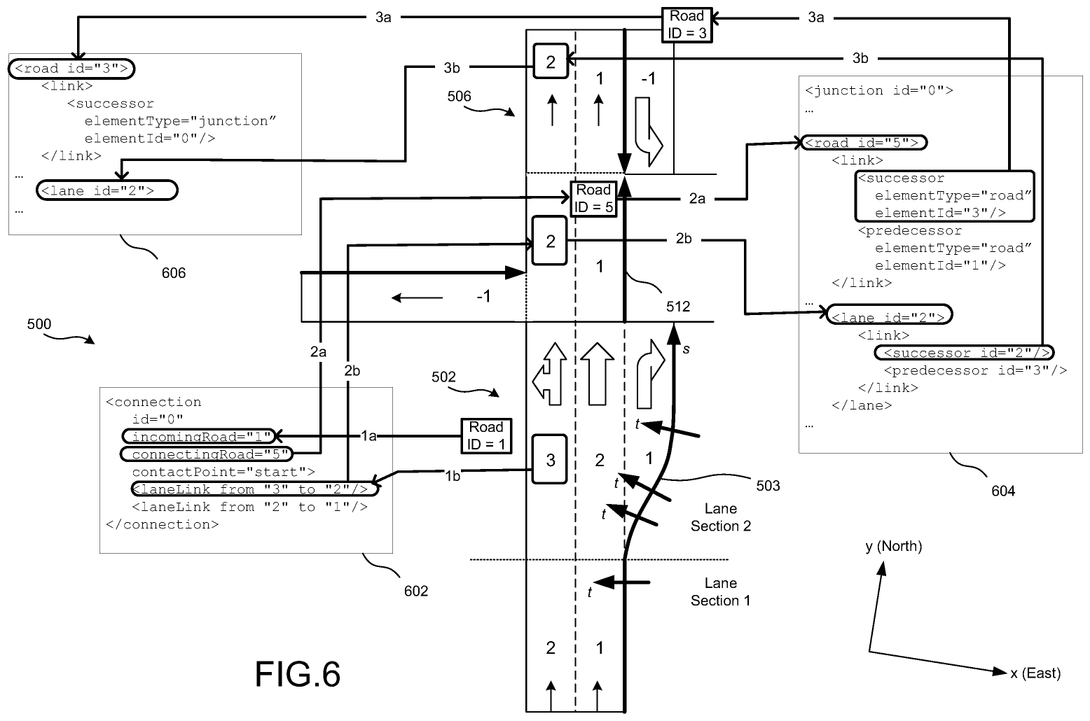

A topological query 422 includes an input descriptor 423 of one or more road structure elements (input elements), and returns a response in the form of an output descriptor 424 of one or more road structure elements (output elements) that satisfy the topological query because they have some defined topological relationship to the input elements. For example, a topological query might indicate a start lane and destination lane, and request a set of “micro routes” from the start lane to the destination lane, where a micro route is defined as a sequence of traversable lanes from the former to the latter. This is an example of what is referred to herein as “microplanning” (see FIG. 6 for further details). Different topological query types may be defined for different types of topological relationships.

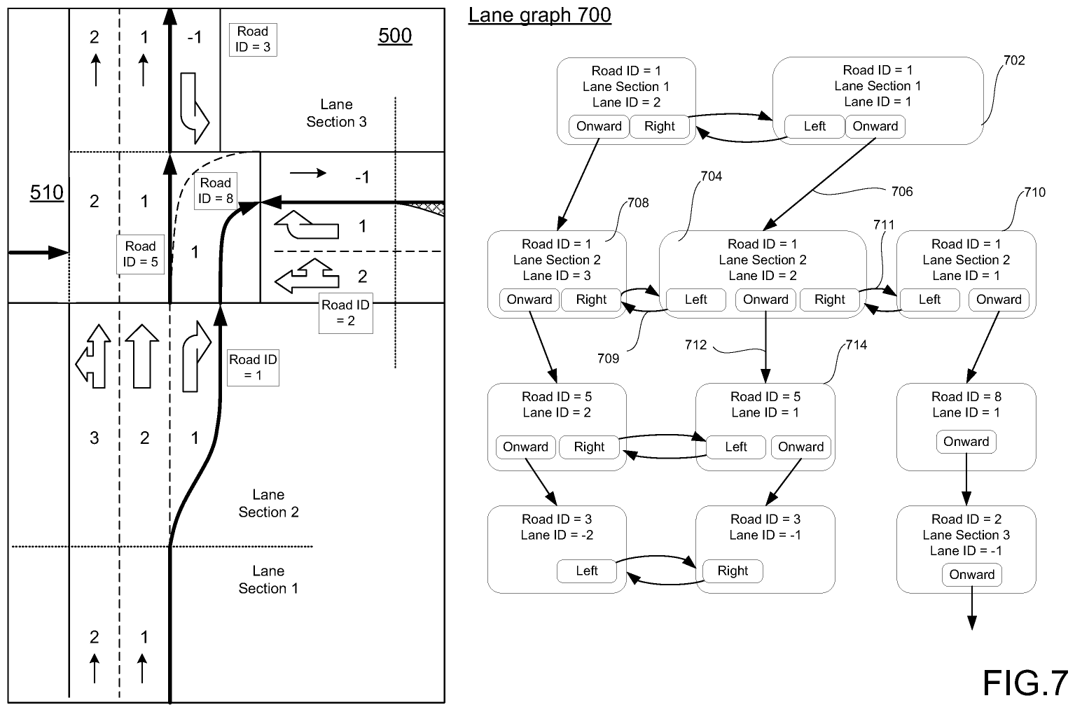

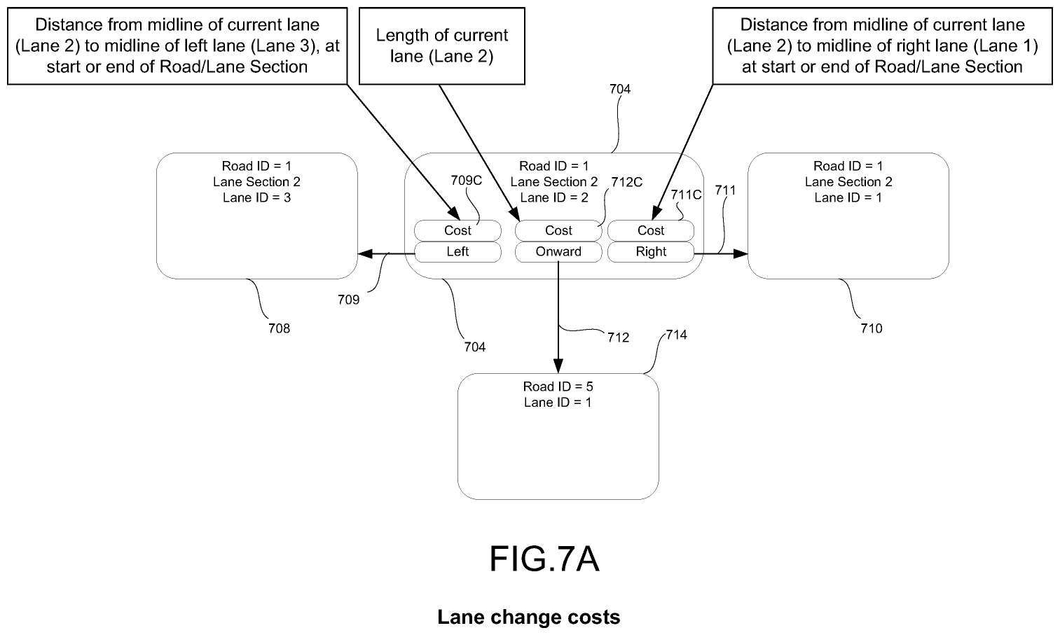

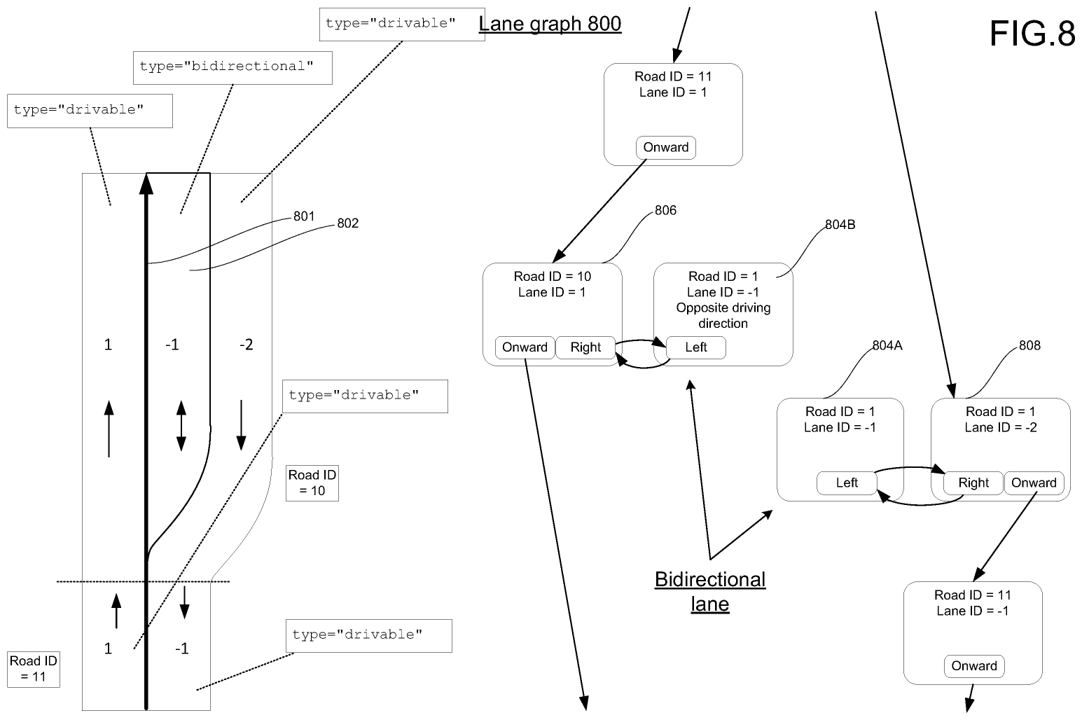

To facilitate topological queries, a topological indexing component 410 builds a topological index 411 of the static layer 414. The topological index 411 is an in-memory graph of road structure elements. Nodes of the graph encode structure elements and edges of the graph represent code topological relationships between the road structure elements. The nodes are embodied in memory as addressable memory locations and the edges as in-memory points to the corresponding memory addresses. Although a single index is depicted, in the examples below, separate topological indexes—a “road graph” and a “lane graph”—are constructed. See FIGS. 7 and 8 for further details.

The second API 426 maps information provided in a descriptor 426 to the corresponding section(s) of the scenario description 412. In response to a descriptor 426 of the static layer 416, the information extraction component 404 provides one or more pieces of scenario data 428 extracted from the corresponding section(s) of the static layer 414. For example, given a descriptor 426 indicating a particular lane, the information extraction component 404 would be able to provide, say, the 3D geometry of the lane from the static layer 414 or some associated piece of information from the dynamic layer 416 (e.g. indicating any agents whose starting locations lie within a particular road or lane).

Geometric and topological queries can be flexibility combined. For example, starting with some geometric constraint(s), a geometric query can return the description of corresponding road(s) or lane(s) (e.g. to find the lane containing the point x). The latter can then be used as the basis for a topological query (e.g. to find all lanes connected to the lane containing the point x).

Both geometric and topological queries return results in a form that can be interpreted in the context of the original static layer 414. A descriptor 420 returned on a geometric query 418 maps directly to the corresponding section(s) in the static layer 414 (e.g. a query for the lane intersecting the point x would return a descriptor that maps directly to the section describing the lane in question). The same is true of topological queries.

Whilst FIG. 4 depicts a driving scenario 412 with both static and dynamic layers 416, the techniques can be applied to a description of a static road layout with no dynamic layer.

A road partition index 407 is also shown, which is generated by a road indexing component 432 and is described in detail below. The road partition index 407 is used to build the geometric index 408, and also to support certain modes of query directly at the SQE API 403. The road indexing component 432 is supported by a road partitioning component 430, whose functionality is described below.

Certain novel concepts underpinning geometric queries within the SQE 402 are summarized in Table 1 below. The concepts are not found in the OpenDRIVE schema, and have been introduced to allow geometric queries to be constructed so that they can be processed quickly.

Table 2 summarizes the construction of the various indexes shown in FIGS. 4 and 4A.

Table 3 summarizes how these indexes are used to support certain modes of query at the SQE API 403.

Tables 1 to 3 refer to certain OpenDRIVE concepts, and further description of these OpenDRIVE concepts follows Table 3. Whilst OpenDRIVE is used as a reference point, the described techniques can be applied to other road network schemas, with the same benefits as set out herein.

TABLE 1
Summary of additional concepts.

| Concept | Description |
|---|---|
| Road | Applicable to road network schemas, such as OpenDRIVE, |
| part. | in which road/lane boundaries are encoded in terms |
| | of multiple functions that can change at arbitrary points |
| | along the road. The number of functions may also change |
| | e.g. as the number of lanes changes. A road part refers |
| | to an s-coordinate interval in which the road is described |
| | by a single fixed subset of the functions of interest. |
| | In other words, within any given road part no change |
| | occurs in any of the functions of interest along the length |
| | of the road part (and the number of functions does not change). |
| | For example, a road reference line might be defined as |
| | a straight line function (f1) on the interval [0, s2) |
| | (its support), a spiral function (f2) on the interval |
| | [s2, s3) and an arc function (f3) on the interval [s3, |
| | s5]. The interval [0, s1) could span a first lane |
| | section with a single side-lane (ID 1) of constant width |
| | (constant width function f4). At s1, a new lane section might |
| | begin with two side-lanes (ID 1 and 2), with the width of Lane 2 |
| | described by a function f5 linearly increasing from zero in |
| | the interval [s1, s4), and then by a constant width function |
| | f6 in the interval [s4, s5]. For simplicity of illustration, |
| | it is assumed that the width of Lane 1 remains constant |
| | throughout, described by f4. In this case, one viable partitioning |
| | of the road that satisfies the above requirements is: |
| | ([0, s1), [s1, s2), [s2, s3), [s3, s4), [s4, s5]). |
| Lane | A lane part refers to a side-lane within a road part in the above |
| part. | sense (an s-interval in which no function of interest changes and |
| | the number of functions does not change). A lane part may be |
| | described by a “bundle” comprising a road partition identifier |
| | (e.g. s-rage of the partition) and a lane ID. |
| | So, in the above example, there are nine lane parts in total - |
| | a single lane part being the lane with ID 1 in the interval [0, |
| | s1), with two lane parts in each of the subsequent intervals |
| | being the portions of the lanes with ID 1 and 2 respectively |
| | contained within that interval. Note the partitioning of the |
| | lanes is defined by the partitioning of the road as a whole, |
| | which in turn is defined by the supports of the full set of |
| | functions of interest. |

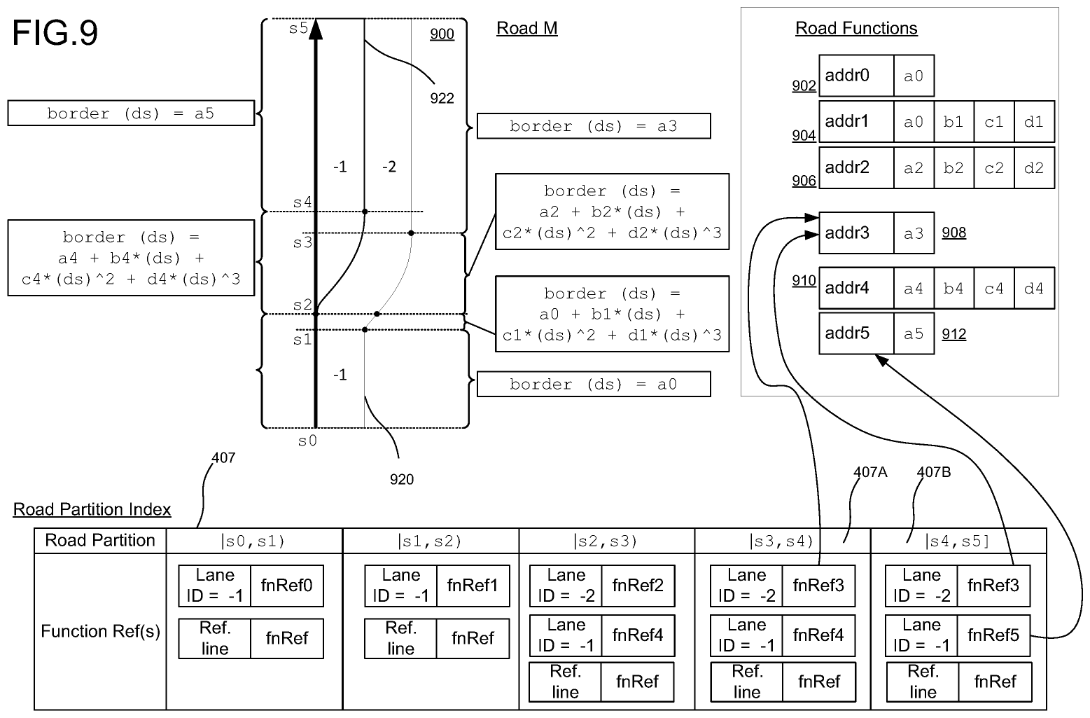

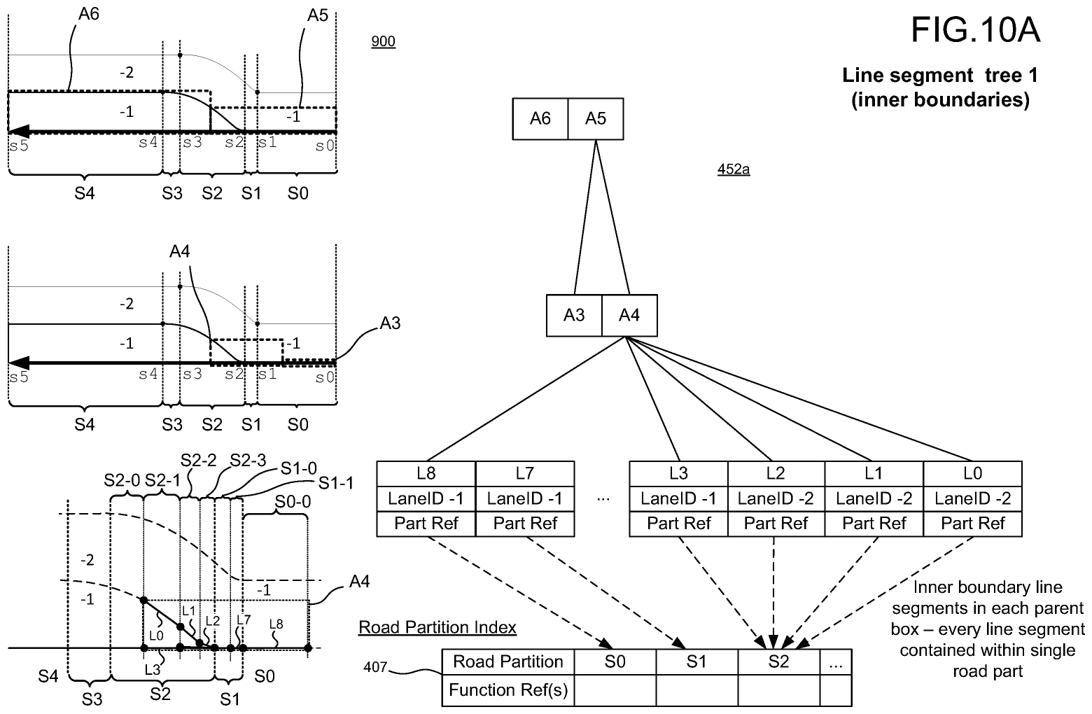

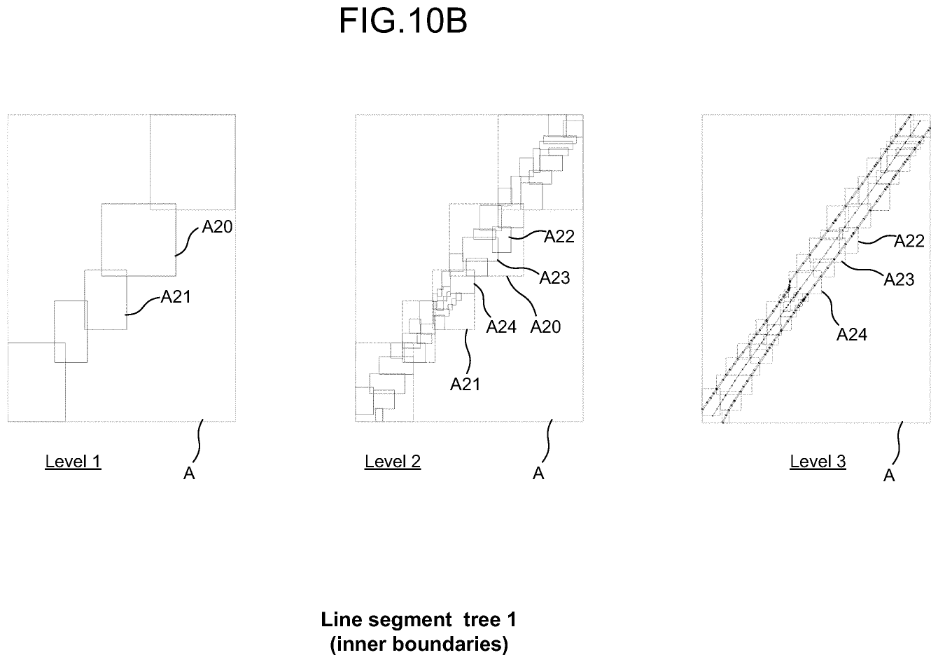

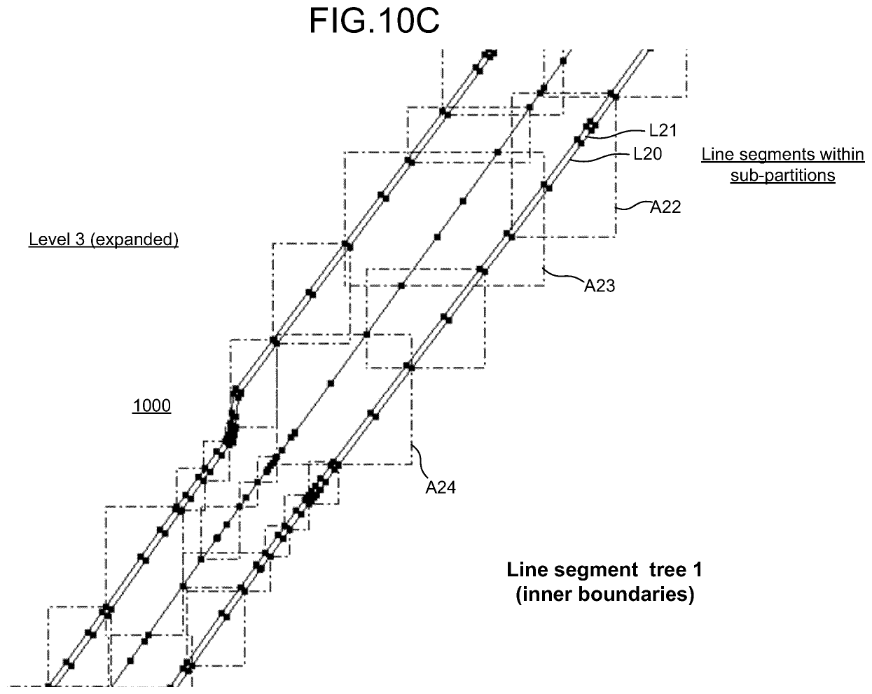

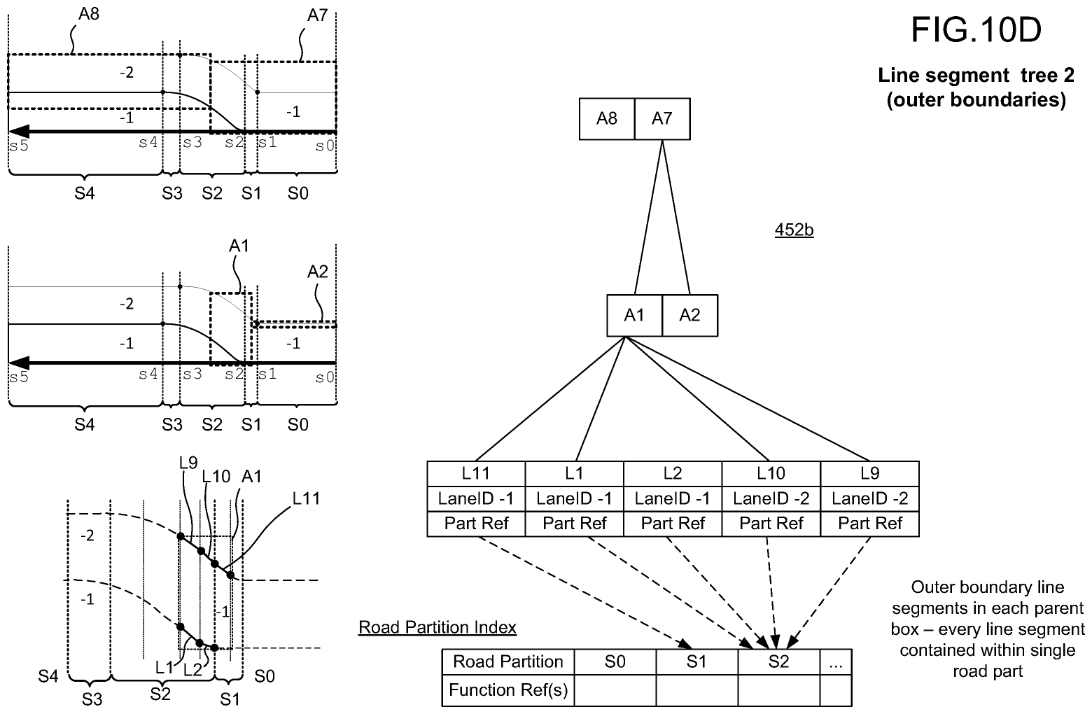

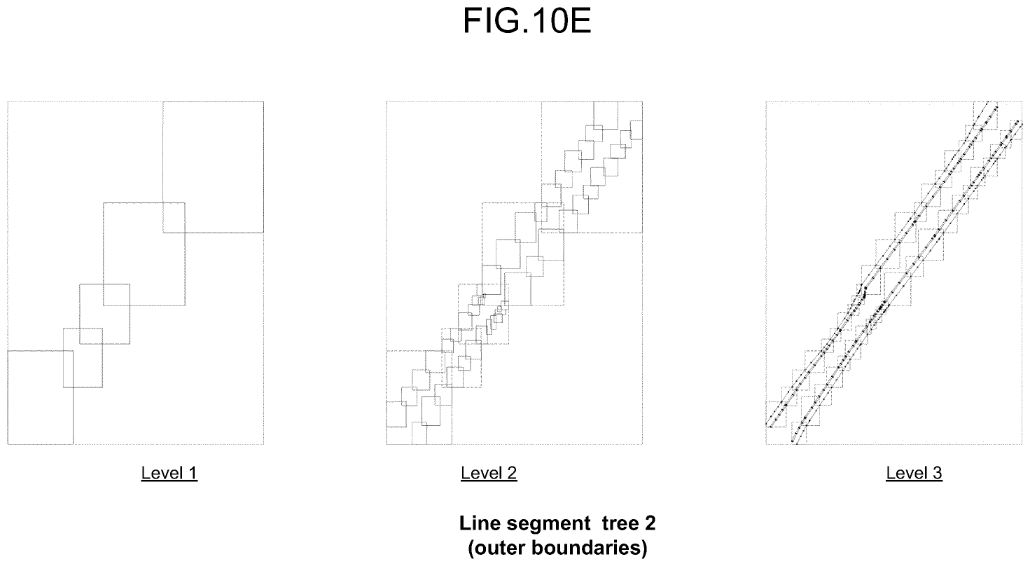

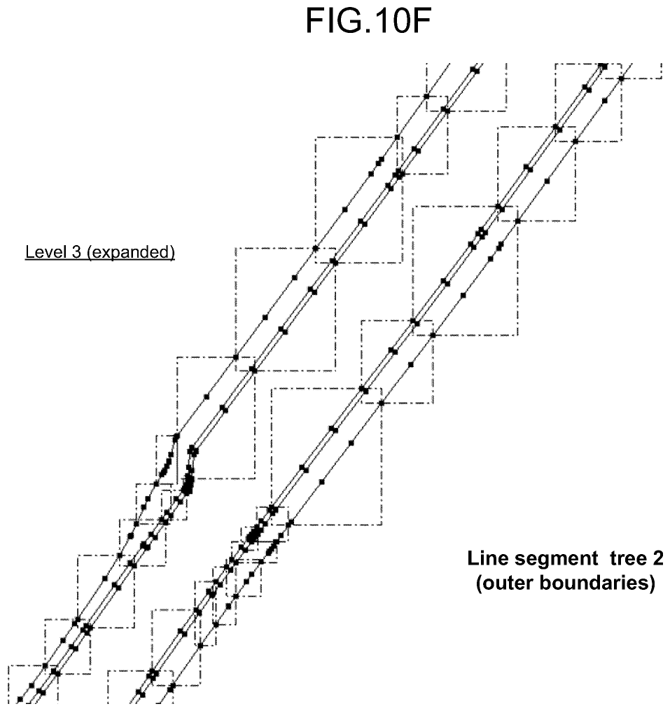

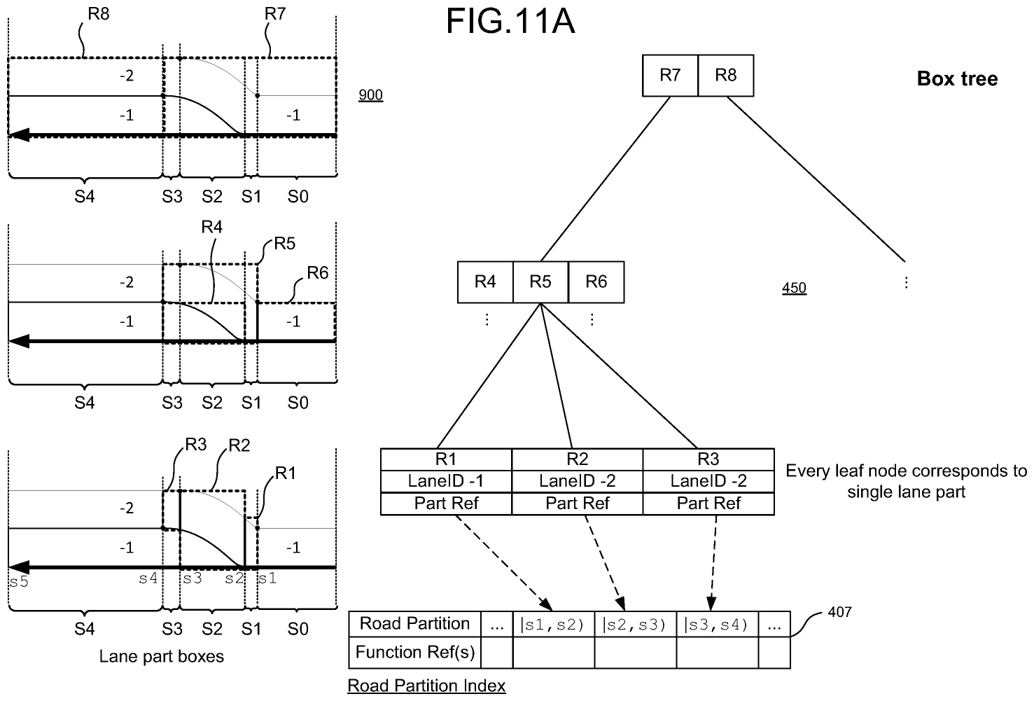

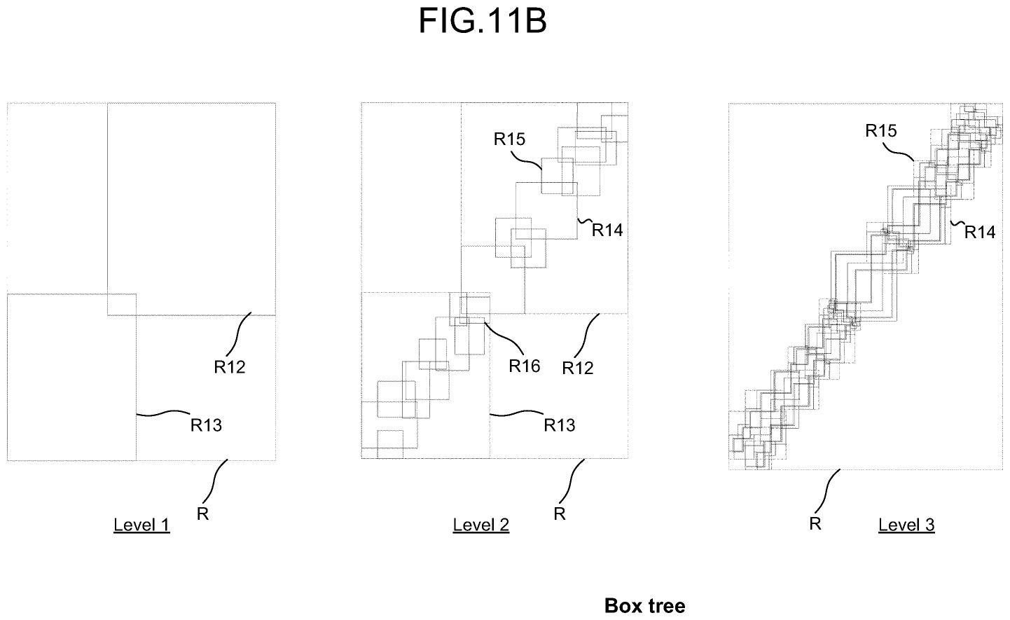

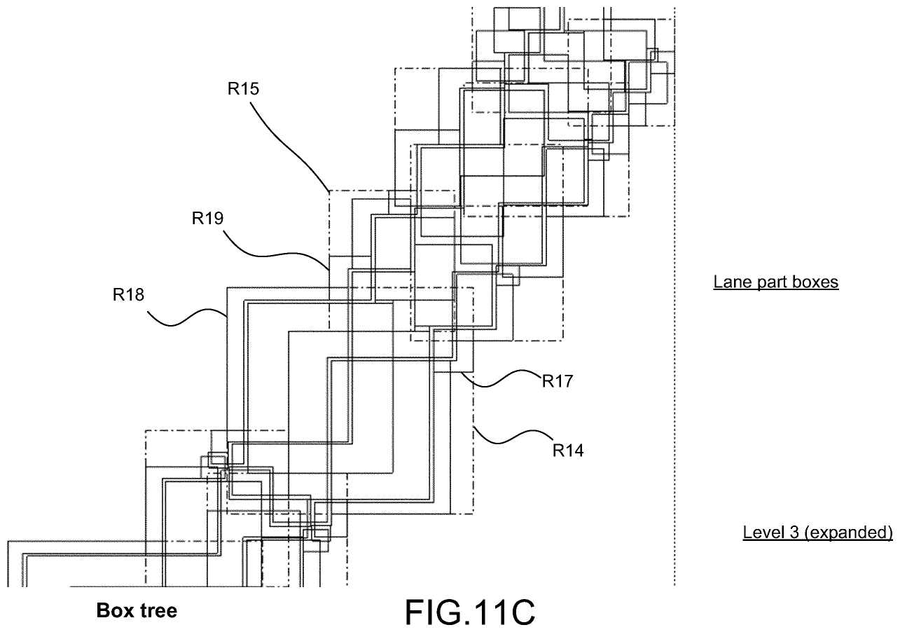

TABLE 2
Summary of indexes.

| | | Illustrative |
|---|---|---|
| Index | Description | FIGS. |
| Topological | A directed graph (side-lane graph) in which nodes represent | FIG. 7: Side-lane |
| index 411. | side-lanes and edges between nodes represent directed lane | graph. |
| | connections between side-lanes (which may or may not be | FIG. 7A: Lane |
| | drivable; e.g. it may be useful to find a sequence of side-lanes | change costs. |
| | navigable by pedestrians). In this context, the term “lane | FIG. 8: Graph with |
| | change” is used in a broader sense, and can include not only | bi-directional side- |
| | left/right lane changes, but also “onward” lane changes from | lane. |
| | one lane to its immediate successor/predecessor (staying in lane | |
| | from the driver's perspective, whilst crossing a boundary | |
| | between connected roads/junctions/lane sections etc. of the road | |
| | network). The existence of a path through the graph from a | |
| | first node to a second node implies the existence of a drivable | |
| | route from the former to the latter, expressed as the | |
| | corresponding sequence of side-lanes (micro-route) to be driven | |
| | by a vehicle. | |
| | Each edge may be associated with a cost that is representative | |
| | of driving distance incurred by the corresponding lane change. | |
| | For a left/right lane change, the cost would generally depend on | |
| | lateral distance from a current lane to its left/right neighbour. | |
| | For an onward lane change from a current lane to an onward | |
| | lane, the cost would generally depend on the length | |
| | (longitudinal extent) of the current lane (which would have to | |
| | be driven to reach the onward lane). | |
| | By and large, there is a one-to-one mapping between nodes in | |
| | the topological index and side-lanes in the underlying | |
| | OpenDRIVE layout, which is desirable to maintain a close | |
| | alignment with the underlying road network representation. Bi- | |
| | directional side-lanes are an exception to this one-to-one | |
| | mapping: a bi-directional lane is represented as two separate | |
| | nodes in the topological index, one for each driving direction. | |
| | In the described implementations, the topological index does | |
| | not leverage the road part and lane part concepts introduced | |
| | above; rather, these are only utilized in the construction and | |
| | processing of geometric queries. | |
| Road | Addresses schemas, such as OpenDRIVE, in which road/lane | FIG. 9: Road |
| partition | boundaries are encoded in terms of multiple functions that can | partition index. |
| index 407. | change at arbitrary points along the road. The number of | |
| | functions may also change e.g. as the number of lanes changes. | |
| | To build a road partition index, a road is partitioned, as set out | |
| | above, based on the supports of the multiple functions of | |
| | interest, such that each road part is described by a single fixed | |
| | subset of the functions of interest. In other words, each road | |
| | part is chosen such that no change occurs in any of the | |
| | functions of interest along the length of the road part (and the | |
| | number of functions does not change). The road partition index | |
| | has an entry for each road part, which in turn contains | |
| | reference(s) to the subset of the functions of interest that | |
| | describe that road part. | |
| | Taking the above example, suppose the functions of interest are | |
| | those describing the road reference line and the functions | |
| | describing the lane widths (this is a simplified example for the | |
| | sake of illustration). In that case, one viable construction of the | |
| | road partition index is: | |
| | [0, s1): (Ref_f1, Ref_f4) | |
| | [s1, s2): (Ref_f1, Ref_f4, Ref_f5) //no. of lanes increases. | |
| | [s2, s3): (Ref_f2, Ref_f4, Ref_f5) //road ref. line fn. changes | |
| | to f2. | |
| | [s3, s4): (Ref_f3, Ref_f4, Ref_f5) //road ref. line fn. changes | |
| | to f3. | |
| | [s4, s5]: (Ref_f3, Ref_f4, Ref_f6) //Lane 2 width fn. changes | |
| | to f6. | |
| | Computation of the lane boundaries requires the road reference | |
| | line and the lane width functions (the lane width function for | |
| | Lane 1 defines its geometry relative to the road reference line; | |
| | the lane width function for Lane 2, in turn, defines the geometry | |
| | of Lane 2 relative to that of Lane 1). In the above example, it is | |
| | guaranteed that the full set of lane boundaries can be computed | |
| | for any given road part with a single subset of functions. | |
| | The road partition index provides extremely fast processing of | |
| | queries on specified road parts. Such a query might contain an | |
| | identifier of a road part (e.g. its s-interval) or a bundle | |
| | describing a lane part (lane ID, road part ID) and ask for, say, | |
| | the (s, t) coordinates on the road of a given (x, y) point, the | |
| | closest point on a lane mid-line to a given (x, y) point, or to | |
| | determine whether a point or box is contained within a given | |
| | road or lane part. Such queries on the road partition index | |
| | could be “internal” (see e.g. “containment queries” below) or | |
| | “external” (meaning that the information identifying the road or | |
| | lane part is provided at the SQE API). | |
| | Only a single set of functions is needed to answer such queries, | |
| | namely the subset of functions referenced in the corresponding | |
| | entry of the road partition index. The query can be answered | |
| | quickly, because it is guaranteed by design that the subset of | |
| | functions needed to do so will not change within the partition in | |
| | question. | |
| Bounding | A spatial (geometric index) that can be used, among other | FIG. 11A: Principles |
| box tree | things, to support fast “containment” queries (e.g. a query that | of construction. |
| 450. | provides a point or box, and asks for all side-lane(s) intersecting | FIGS. 11B-C: More |
| | the point/box). Each leaf node contains a bounding box of a | realistic box |
| | lane part (a lane or lane portion within a road part) and a bundle | examples. |
| | uniquely identifying the lane part, namely a lane ID, and some | |
| | reference to the entry in the road partition index for the | |
| | corresponding road part (e.g. the s-coordinate interval for the | |
| | road part or some other identifier of the road part that can be | |
| | used to locate the entry in the road partition index). | |
| | The “internal” parent/child structure of the tree is not required | |
| | to have any specific correspondence to the road structure, in | |
| | that leaf nodes can be grouped in any way to support fast | |
| | queries (which would typically mean grouping together nearby | |
| | boxes). A self-balancing tree may be used that adapts | |
| | parent/child relationships dynamically. | |
| | The road partition index is used to build the bounding box tree. | |
| | Recall that each leaf node corresponds to a single lane part. In | |
| | order to compute the bounding box of the leaf node, the | |
| | geometry of the lane part is first computed using the single set | |
| | of fixed functions referenced in the road partition index. It is | |
| | then straightforward to compute bounding box coordinates for | |
| | the lane part in question. The leaf node is populated with the | |
| | bounding box coordinates, and a bundle comprising the lane ID | |
| | and a reference to the corresponding road part in the road | |
| | partition index. | |
| Line | A spatial (geometric index) that can be used, among other | FIG. 10A: Inner |
| segment | things, to support fast “distance” queries (e.g. a query that | boundary tree. |
| tree(s) 452a, | provides a point for the closest side-lane(s) to the point). Each | FIGS. 10B-C: More |
| 452b. | leaf node contains a straight line segment that approximates a | realistic examples of |
| | boundary on a given interval, which is fully contained within a | inner boundary |
| | single road part (that is, no line segment crosses the boundary | segments. |
| | between different road parts). In the described implementation, | FIG. 10D: Outer |
| | each line segment is computed for a single boundary within a | boundary tree. |
| | sub-interval of a given road part, where the size of the sub- | FIGS. 11E-F: More |
| | interval decreases with road/lane curvature to maintain a certain | realistic examples of |
| | level of accuracy in the line segment approximation. Each leaf | outer boundary |
| | node also contains a bundle describing the lane part to which it | segments. |
| | belongs (which may result in significant duplication of | |
| | references across the leaf nodes of the tree, particularly with | |
| | narrow sub intervals). | |
| | In the described implementation, two separate line segment | |
| | trees are built on inner and outer boundaries respectively. | |
| | Within a road, most lines serve as both inner and outer | |
| | boundaries - e.g. in a road with Lanes 1 and 2, the outer | |
| | boundary of Lane 1 is the inner boundary of Lane 2. The outer | |
| | boundary of the outermost lane is not an inner boundary. In a | |
| | two-way road, the boundary between Lane 1 and Lane −1 is not | |
| | an outer boundary, but is the inner boundary to both Lane 1 and | |
| | Lane −1, and its line segments are indexed twice in the inner | |
| | boundary tree 452b (in association with Lane 1 and Lane −1 | |
| | respectively). | |
| | In the inner boundary tree 452a, each leaf node contains a line | |
| | segment, a bundle describing the lane part of which that line | |
| | segment is an inner boundary. In the outer boundary tree 452b, | |
| | each leaf node contains a line segment, a bundle describing the | |
| | lane part of which that line segment is an outer boundary. A | |
| | given line segment may appear in both trees, but with different | |
| | lane IDs and flags. | |
| | Each direct parent node of a set of leaf nodes contains a | |
| | bounding box around all line segments of its child nodes, and | |
| | each parent of non-leaf nodes contains a bounding box around | |
| | the bounding boxes of children. | |
| | The “internal” parent/child structure of the tree is not required | |
| | to have any specific correspondence to the road structure, in | |
| | that leaf nodes can be grouped in any way to support fast | |
| | queries (which would typically mean grouping together nearby | |
| | line segments at the leaf level, and near boxes higher up the | |
| | tree). Line segments from different road parts may therefore be | |
| | grouped together under the same direct parent. A self- | |
| | balancing tree may be used that adapts parent/child | |
| | relationships dynamically. | |
| | The road partition index is used to build the bounding box tree. | |
| | Recall that each leaf node corresponds to a line segment | |
| | contained within a single road part. The line segment is | |
| | computed using the single set of fixed functions referenced in | |
| | the road partition index. It is then straightforward to compute | |
| | bounding box coordinates for all line segments under a | |
| | common parent node, and to compute bounding boxes for | |
| | parent nodes higher up the tree. | |

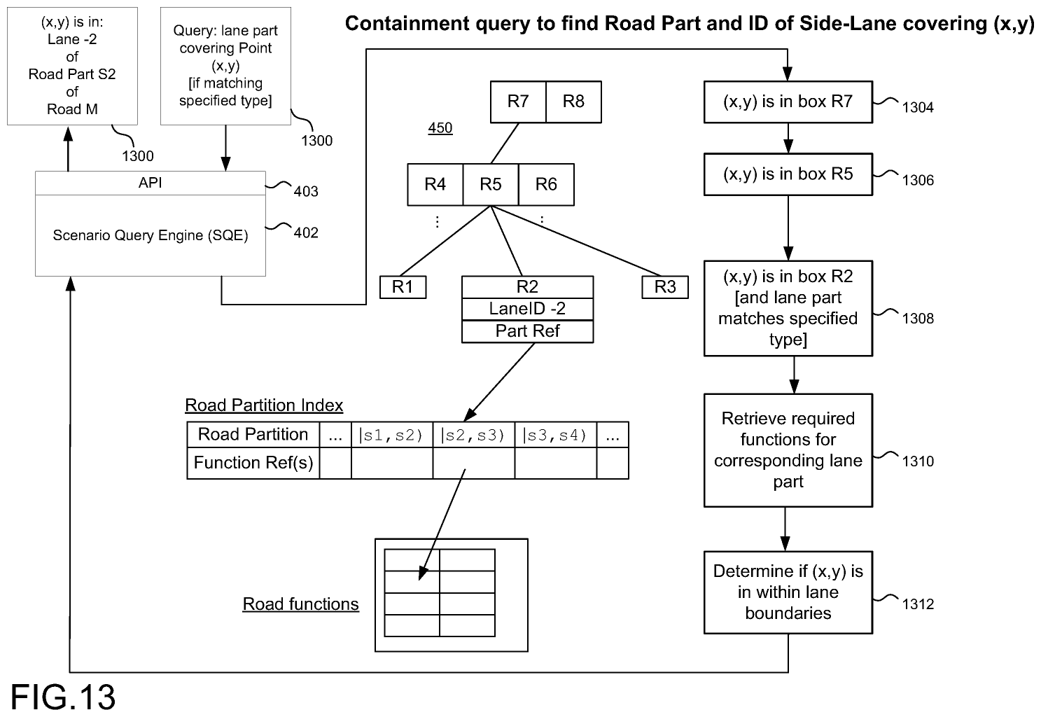

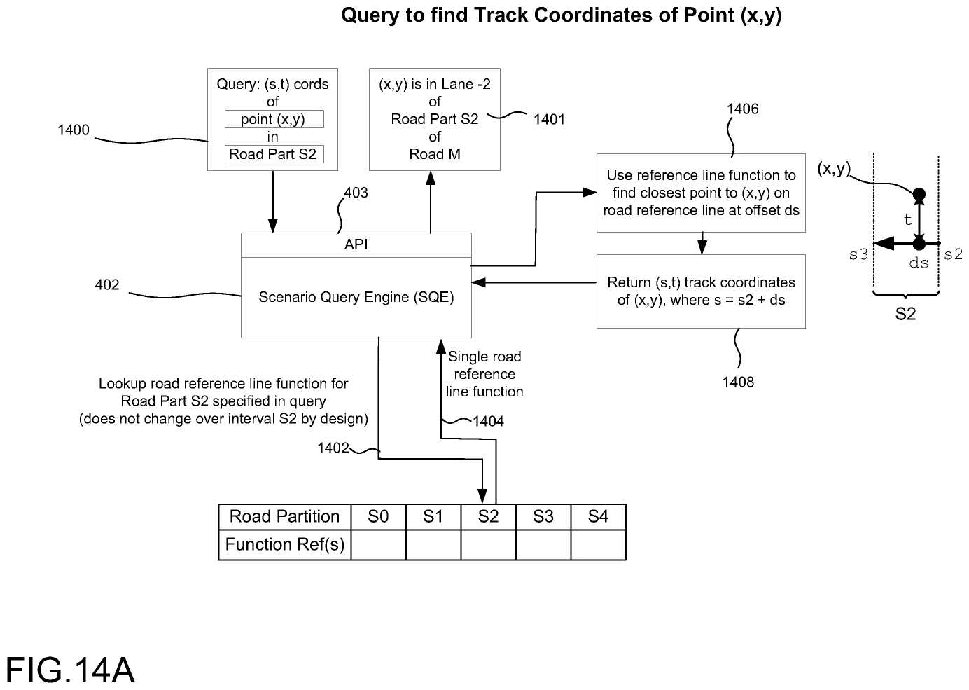

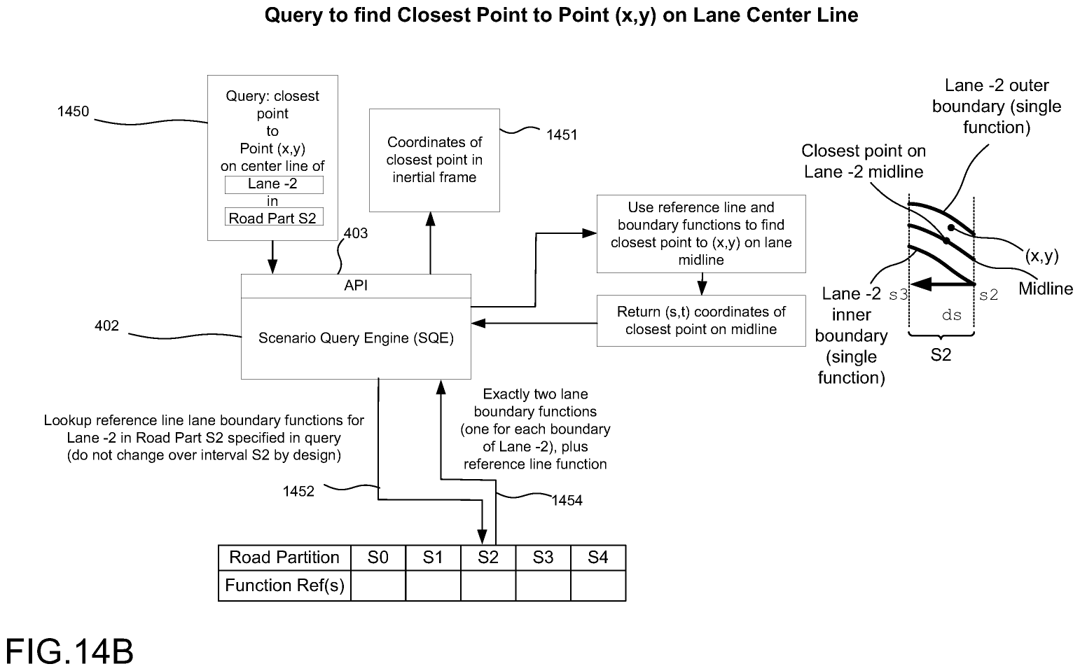

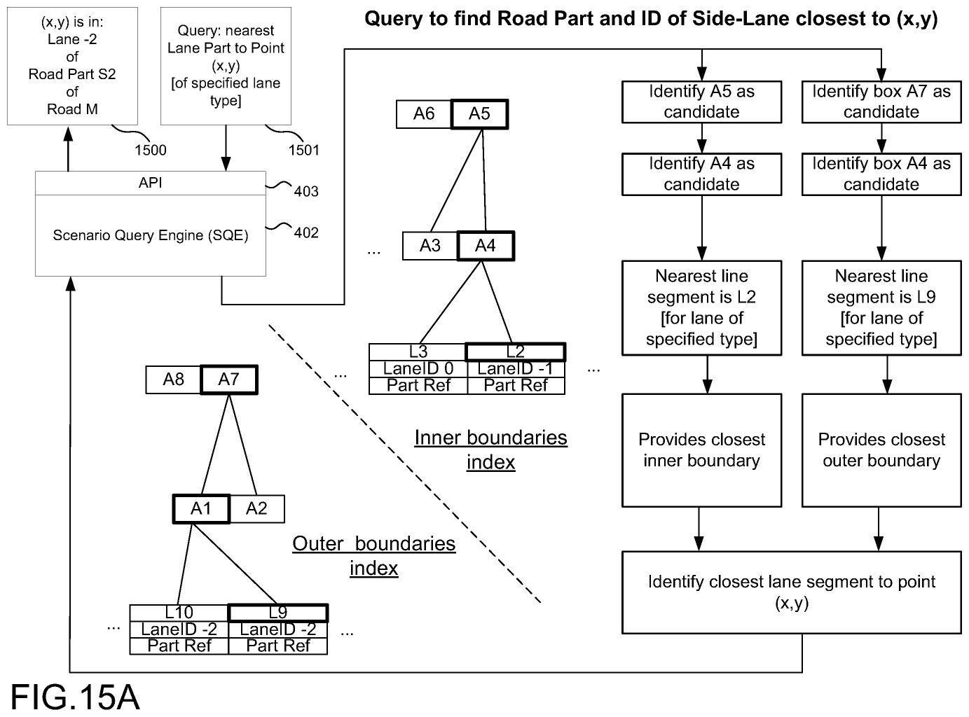

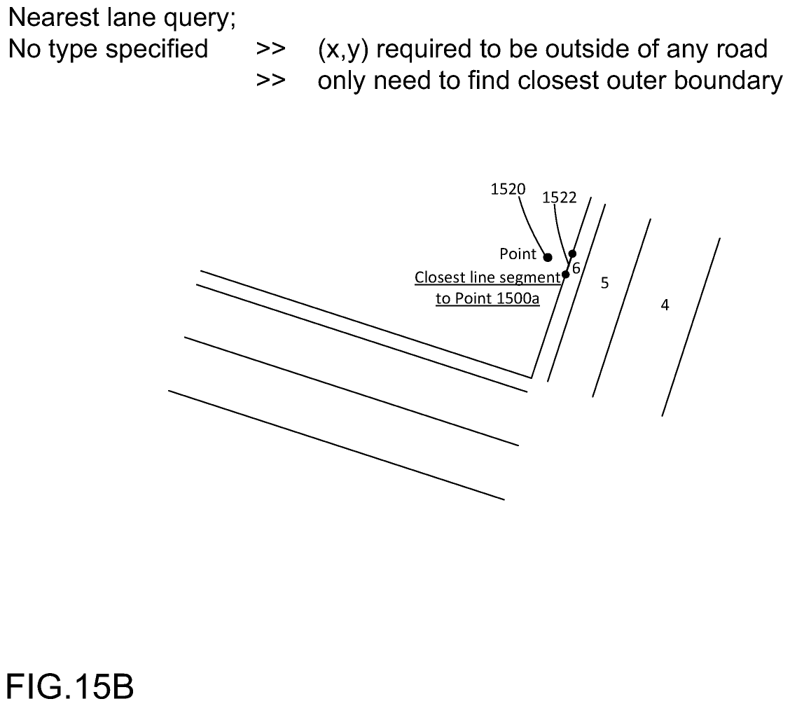

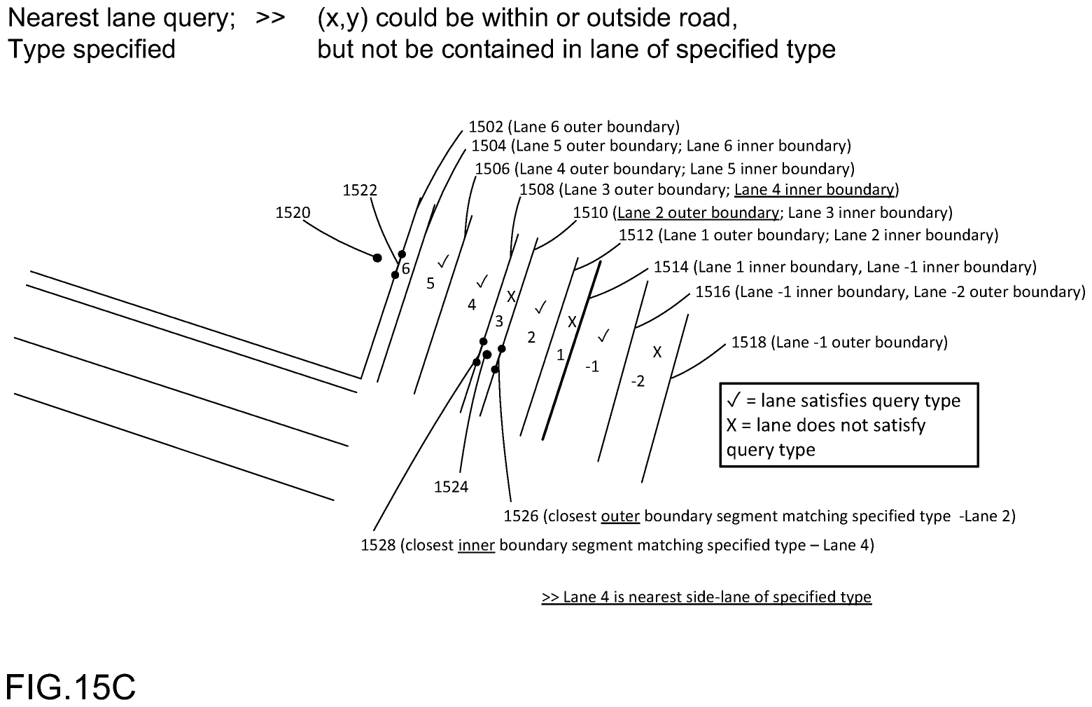

TABLE 3
Summary of query modes.

| | Supporting | | Illustrative |
|---|---|---|---|
| Query mode | indexes | Description | FIGS. |
| Containment. | Bounding box | A containment query is answered in two phases. | FIG. 13: |
| | tree (phase 1); | The box tree is first used to obtain a set of candidate | Containment |
| | Road partition | lane part(s), whose bounding box(es) intersect the | query. |
| | index (phase | point/box in question. This is not definitive, as a | |
| | 2). | bounding box for a given lane part will, in most | |
| | | cases, span one or more regions outside of the lane | |
| | | part. The second phase of the query uses the road | |
| | | partition index to answer the query definitively. | |
| | | Recall that each leaf node contains the bundle for | |
| | | the lane part in question. This, in turn, allows the | |
| | | required functions to be retrieved using the road | |
| | | partition index (an “internal” query on the road | |
| | | partition index, triggered by the containment | |
| | | query). By design, this is a single set of functions | |
| | | that does not change within the road/lane part. | |
| | | Using this single set of functions, the required | |
| | | geometry of each candidate lane part can be | |
| | | computed to any desired accuracy, and used to | |
| | | answer the query in respect of that lane part | |
| | | definitively. | |
| | | The response to a containment query provides the | |
| | | bundle(s) describing the lane part (or each lane part) | |
| | | satisfying the query. The bundle can, in turn, be | |
| | | used in a further external query pertaining to the | |
| | | road/lane geometry on the road partition index (see | |
| | | “road partition queries” below) | |
| | | A containment query returns a null response if the | |
| | | point/box does not intersect any side-lane. A | |
| | | containment query may also be type-specific, in | |
| | | which case a null response is returned if the | |
| | | point/box is not contained within any side-line of | |
| | | the specified type (even if it is contained within a | |
| | | side-lane of some other type). | |
| Distance. | Line segment | A distance query asks for the closest side-lane to a | FIG. 15A: |
| | tree(s). | given (x, y) point or box. A distance query may be | Distance |
| | | type-specific, and ask for the closest side-lane of a | query. |
| | | type specified by a set of query flag(s). | FIG. 15B: |
| | | In general, one has to find both the nearest inner | Distance |
| | | and outer boundary and then chose that which is | query for |
| | | closest (assuming that the query point is not | point outside |
| | | covered by the relevant sub-set of side-lanes). | of road |
| | | In the specific case of a distance query that is not | boundaries. |
| | | type-specific, the SQE 402 assumes the given point | FIG. 15C: |
| | | (or box) is not contained in any side-lane, and | Type-specific |
| | | therefore lies outside the boundaries of the road. In | distance |
| | | this case, it is sufficient to find the closest outer | query for |
| | | boundary line segment to (x, y) via a search on the | point within |
| | | outer boundary tree only. Therefore, before making | side-lane of |
| | | the distance query, generally a non-type-specific | different |
| | | containment query should be run (unless it is | type. |
| | | already known that the point (x, y) lies outside of the | |
| | | road boundaries), and the distance query should | |
| | | only be run if the containment query returns a null | |
| | | result. | |
| | | To respond to a type-specific distance query, | |
| | | similar principles apply, in so far as the SQE | |
| | | assumes the point (x, y) (or box) is not contained in | |
| | | a side-lane of the specified type, although a search | |
| | | is required on both trees (see above). Therefore, | |
| | | generally speaking, a type-specific containment | |
| | | query should be run first, and the type-specific | |
| | | distance query should only be run if this returns a | |
| | | null result. | |
| | | Geometric rules are constructed for identifying | |
| | | viable branches of a line segment tree based on | |
| | | parent bounding boxes. Given a set of parent | |
| | | bounding boxes at a particular level in the tree, it is | |
| | | generally possible to exclude most of these, on the | |
| | | basis that they could not possibly contain the closest | |
| | | line segment to the point (x, y). | |
| | | The above assumptions leverage the respective | |
| | | benefits of the box tree and the line segment tree(s). | |
| | | A containment query can be answered more | |
| | | efficiently with a search on the box tree, whereas a | |
| | | distance query can be answered efficiently on the | |
| | | line segment(s) in the case that lack-of containment | |
| | | does not need to be verified. | |
| | | Of course, distance and containment could be | |
| | | contained in a single API query. Such a query | |
| | | would be answered first with a search on the | |
| | | containment tree and road partition index to | |
| | | ascertain containment (type-specific or non-type | |
| | | specific), in the same way as a containment query, | |
| | | followed by a search on the line segment tree(s) in | |
| | | the case of a null containment result. | |
| | | The response to a distance query provides the | |
| | | bundle(s) describing the lane part (or each lane part) | |
| | | satisfying the query. The bundle can, in turn, be | |
| | | used in a further query pertaining to the road/lane | |
| | | geometry on the road partition index (see “road | |
| | | partition queries” below). | |
| Road | Road partition | A broad class of query that can be answered from | FIG. 14A: |
| partition. | index. | the road partition index directly. A “road partition | Query to find |
| | | query” contains an identifier of a road part (e.g. s- | (s, t) track |
| | | interval) or a bundle describing a lane part (lane ID, | cords. of |
| | | road part ID). Typically, this information would be | (x, y) point. |
| | | obtained via an earlier containment or distance | FIG. 14B: |
| | | query. These are “external” queries on the road | Query to find |
| | | partition index, in that the road/lane part in question | closest point |
| | | is specified in a query at the API (in contrast to the | to (x, y) on |
| | | internal query on the road partition index in the | lane mid-line. |
| | | second phase of responding to a containment | |
| | | query). | |
| | | Examples include a query to to find corresponding | |
| | | (s, t) coordinates in a specified road part of a given | |
| | | (x, y) point, to find the closest point to (x, y) on the | |
| | | midline of the lane part etc.), again leveraging the | |
| | | performance benefits of the road partition index. | |
| Route | Topological | A query that returns a micro-route from a first | Cost-based |
| planning. | index. | specified side-lane to a second specified side-lane | search on |
| | | having lowest overall costs. The SQE performs a | lane graph of |
| | | search on the topological index to find the lowest- | FIGS. 7-7A. |
| | | cost path through the tree from the node of the first | |
| | | side-lane to the node of the second-side lane. Any | |
| | | cost-based tree search can be used (a depth first | |
| | | search is used in the described implementation). | |
| | | To obtain the first and second side lanes, geometric | |
| | | queries can be used e.g. to find the side-lane | |
| | | containing a given point/box or the closest side lane | |
| | | to a given point/box. | |

For type-specific queries using the above trees, any side-lane attributes that are required are retrieved direct from an in-memory representation of the document containing the static layer 414. A predicate is applied to the entire tree and only those indexed values that satisfy the predicate are considered. A range of predicates may be supported (e.g. lane-type, supporting road-type (in-junction or not), etc.) and arbitrary combinations may also supported, e.g. ‘get me the nearest side-lane that is a driving or a biking lane that is in a junction’. Hence, in FIG. 9, the depicted road functions 902, . . . , 910 may be stored within the in-memory representation of the document itself, and retrieved from the in-memory representation of the document using a bundle returned by the road partition index 407.

Road/lane attributes are not stored within the spatial indices in the described examples (but could be in other implementations). Rather, the index is first filtered based on the active predicate(s) and the query is run on the filtered index (such that element that do not satisfy the active predicate(s) are not considered in processing the query).

As will be appreciated, the specific choices of index and query types summarized above are not intended to be exhaustive, but are merely illustrative of how the techniques may be applied in a particular implementation.

### Example Road Network:

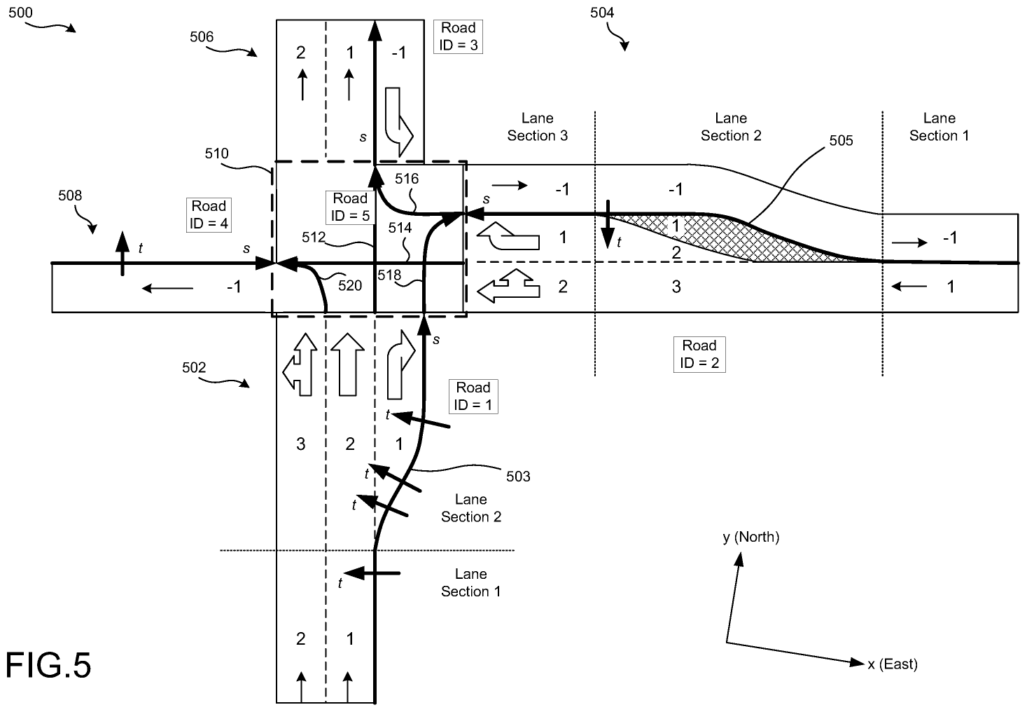

FIG. 5 schematically depicts an example road network 500 of the kind encoded in the static layer 414. The following description assumes the road network 500 is described using the OpenDRIVE schema, or a similar format that adopts certain definitions and conventions from OpenDRIVE. However, it will be appreciated that the principles extend more generally to other formats, and the described techniques are not limited to any particular data format or schema.

The road network 500 is shown to comprise first, second, third and fourth roads 502, 504, 506, 508 (Roads 1 to 4), which are described with <road> elements having road identifiers (IDs) 1, 2, 3 and 4 respectively. The roads 502-508 are interconnected via a junction 510 described by a <junction> element. Each of the roads 502-508 is defined by a single road reference line, denoted as a thick solid arrow, and contains a single center lane of width zero. The center lanes are not depicted separately, and for simplicity it is assumed that the center lane of each road 502-508 lies along the road reference line (although, as noted, it is possible to define a non-zero offset between the road reference line and the center lane). The road reference lines of the first and second roads 502, 504 are denoted by reference numerals 503 and 505 respectively. A road reference line is directional, and could be described more precisely as a longitudinal axis or “s-axis” of the road, with s-coordinates running along that axis, and t-coordinates running orthogonal to it. As depicted for the reference lines 503, 505, the positive t-direction is defined as extending to the left of the s-axis. Lanes are numbered relative to the center lane; the center lane is always numbered 0, with side-lanes to the left of the center lane (+t) assigned incrementing positive lane numbers (1, 2, 3, . . . ) and lanes to the right (−t) assigned decreasing negative lane numbers (−1, −2, −3, . . . ).

Each side-lane has a lane-type, and the possible types are partitioned into those that support only one-way driving and those that support bidirectional driving. A “side-lane direction” concept is introduced into the SQE API 403 to handle this. The direction of a one-way side-lane can then be deduced from the orientation of the road reference-curve and the road traffic rule for the supporting road, which is provided by the scenario description 412.

Each road has a minimum of one side-lane. In this example, the first road 502 has only positively numbered side-lanes to the left of the center lane, whereas the second road 504 has two positive side-lanes to the left of the center lane, and one negative side-lane to the right. Roads may be divided into “lane sections” to accommodate sections of the road with different numbers of lanes (see below).

In the following description, “Lane n” means a lane with lane number “n” and “Road m” means a road with road ID “m”. Other road elements (such as junctions) are referred to in the same way. In OpenDRIVE, lane sections are not assigned explicit identifiers. Relationships between the side-lanes in successive lane-sections within a single road are explicitly described in the static layer description 416 through lane-links and these are used in building the part of the topological index 411 supported by the road. Neighbouring relationships are implicit in the side-lane numbering system, although the directed side-lane graph does not support edge traversal that crosses a center lane, as this implies movement into an oncoming traffic flow (see below regarding bidirectional side-lanes).

For conciseness, adjacent lane sections may be referred to as “Lane Section n” and “Lane Section n+1”, even though the lane section numbers n, n+1 does not form part of the OpenDRIVE schema.

A left-hand traffic (LHT) road system is depicted in this example. However, the schema can be used for either LHT or right-hand traffic (RHT) networks. A “rule” attribute of each <road> element indicates whether the road is LHT (vehicles drive on the left) or RHT (vehicles drive on the right).

A global cartesian coordinate system is defined with the x-direction lying eastwards and the y-axis extending northwards (OpenDRIVE calls this the inertial coordinate system).

Lane numbers only indicate relative directions of traffic flow within a road: for any given road, traffic flows in the same direction for positively-numbered one-way side-lanes, and in the opposite direction for negatively-numbered one-way side-lanes. Bi-directional lanes support traffic flow in both directions irrespective of the road traffic rule. However, the lane number alone is not sufficient to infer the direction of traffic flow, as the direction of the s-axis can be (more or less) arbitrarily chosen and does not indicate driving direction. For example, in FIG. 5, the s-axis 505 of the second road 504 extends towards the junction from the east, whilst the s-axis of the fourth road 508 extends in the opposite direction towards the junction 510 from the west. Along the second road 504, positive lane numbers therefore denote a direction of traffic flow from east to west, whereas along the fourth road 508, east-to-west traffic flow is denoted by negative lane numbers. For a LHT road, lanes to the left of the road reference line (+t) carry traffic in the direction of the road reference line (+s), whereas lanes to the right of the road reference line (−t) carry traffic in the opposite direction (−s). In an RHT road, lanes to the left of the road center line (+t) carry traffic in the opposite direction of the road reference line (−s) and lanes to the right (−t) carry traffic in the direction of the road reference line (+s).

It is also possible to define a bidirectional side-lane, permitting traffic flow in both directions, by setting a @type attribute of the <lane> element to “bidirectional”. Bidirectional lanes are addressed in more detail below.

Therefore, in order to determine the absolute direction of traffic flow, the lane number is not sufficient; the direction of the road reference line (s-axis) must also be considered, as must the @type attribute.

Lanes are not necessarily drivable. For example, Lane 1 of Lane Section 2 of Road 2 is non-drivable. The outer boundaries of a road may also be defined by non-drivable lanes (such as lanes of a pavement/sidewalk type).

Link elements are used to explicitly define linkage between roads and lanes. With only two roads, links can be defined with link elements between roads directly, provided the links are unambiguous. More complex linkage requires the use of junction elements.

A <link> element can have one or both of a <successor> element and a <predecessor> element. The predecessor/successor of a road can be another road or a junction. The predecessor/successor of a lane is another lane. “Predecessor” and “successor” relationships are defined relative to the s-axis of the road in question (a road's t-axis runs from its predecessor, if any, to its successor, if any), and do not denote driving direction. The s-axis of a road runs away from its predecessor (if any), towards its successor (if any).

Predecessor/successor relationships may be ‘asymmetrical’. For example, if Road n is a predecessor of Road m, that does not imply Road m is a successor of Road n; if the s-axis of Road n runs in the opposite direction to the s-axis of Road m, then Road m could also be a predecessor of Road n. As another example, if Road m is part of a junction, then Road m cannot be a predecessor or successor of Road n, because the junction would be the predecessor/successor of Road n instead (see below for further examples).

Roads with varying number of lanes are accommodated using lane sections. Within the OpenDRIVE schema, lanes are described within a <lanes> element of a <road> element. A <lanes> element may be split into multiple sections (lane sections) with a <laneSection> element. Each individual lane is defined by a <lane> element within the <laneSection> element.

Each lane section has a fixed number of lanes, numbered as per the above convention. For example, the first road 502 is shown divided into two lane sections (Lane Sections 1 and 2 of Road 1): approaching the junction 510, the number of lanes is shown to increase from two to three. On entering Lane Section 2 from Lane Section 1 of the first road 502, a new rightmost lane is created, whose width gradually increases from zero. In Lane Section 1, the left and right most lanes (to the left of the center lane) are numbered 2 and 1 respectively, whilst in Lane Section 2 the left-most lane and new right-most lanes are numbered 3 and 1 respectively; what is now the middle lane is numbered 2.

Links between lanes in adjacent lane sections are described using <link> elements. In Lane Section 2, Lane 2 of Lane Section 1 is a predecessor of Lane 3 of Lane Section 2, and Lane 1 of Lane Section 1 is a predecessor of Lane 2 of Lane Section 2. That is to say, the lane element describing Lane 3 of Lane Section 2 would contain a link element indicating Lane 2 as its predecessor, and it is implicit that the link refers to the immediately preceding lane section (Lane Section 1) etc.

Likewise, in Lane Section 1, Lane 3 of Lane Section 2 is a successor of Lane 2 of Lane Section 1, and Lane 2 of Lane Section 2 is a successor of Lane 1 of Lane Section 1. That is, the lane element describing Lane 2 of Lane Section 1 would indicate Lane 3 as its successor, and it is implicit that the link refers to the next lane section (Lane Section 2) etc.

Because Lane 1 of Lane Section 2 has zero width initially, it is not linked to any lane of Lane Section 1. It is, however, possible for a lane to have multiple successors or predecessors in different circumstances, for example if a lane splits immediately into two lanes, each of non-zero width at the lane section boundary.

Within the junction element 510 of Figure, additional roads are defined, whose reference lines are depicted as thick, solid arrows. Fifth to ninth roads 512, 514, 516, 518, 520 (Roads 5 to 9) are depicted within the junction 510 in this example. Although side-lanes within the junctions 510 are not depicted in FIG. 5, each road within the junction 510 is also required to have at least one side-lane of non-zero width.

In FIG. 5, the junction 510 is a successor of the first, second and fourth roads 502, 504, 508 because their respective s-axes extend towards the junction 510. Therefore, the <road> elements describing those roads 502, 504, 508 would contain <link> elements with <successor> elements indicating the junction 510. The junction 510 is a predecessor of the third road 506 because its s-axis extends away from the junction, and the <road> element describing the third road 506 would therefore contain a <link> element with a <predecessor> element indicating the junction 510.

Within the junction element 510, connecting roads are described by <road> and <connection> elements.

The fifth road 512 (Road 5) is shown to connect the first and third roads 502, 506. The fifth road 512 is defined by a <road> element within the <junction> element 510, of which the first road 502 is a predecessor and the third road 506 is a successor (defined via <predecessor> and <successor> elements in the <road> element describing the fifth road 506). Similarly the sixth road 514 has the fourth road 508 as its successor and the second road 504 as its predecessor. The seventh road 516 connects the second and third roads 504, 506, with the second road 504 as its predecessor and the third road 506 as its successor. The eighth road 518 connects the second and first roads 504, 502, with the second road 504 as successor and the first road 502 as predecessor. Finally, the ninth road 520 connects the first and fourth roads 502, 508, with the fourth road 508 as its successor and the first road 502 as its predecessor. Again, the predecessor/successor relationships are not direct indicators of driving direction.

A <connection> element is used to indicate driving direction for traffic joining a junction. A connection element indicates an incoming road and a connecting road (but does not explicitly define an outgoing road), with traffic entering the junction from the incoming road onto the connecting road. For example, a first <connection> element would be provided that indicates the road with ID=1 (the first road 502) as an incoming road and the road with ID=5 (the fifth road 512) as a connecting road; this connection element indicates that traffic can enter the junction 510 from the first road 502 onto the fifth road 512. A second <connection> element would indicate the first road 502 as an incoming road and the eighth road 518 as a connecting road, etc. The seventh connecting road 516 is a two-way road in this example, carrying traffic from the second road 504 to the third road 506, and traffic in the opposite direction. Therefore, two <connection> elements would be used, one indicating the second road as incoming and the seventh road 516 as connecting, and the other indicating the third road 506 as incoming and the seventh road 516 as connecting. The OpenDRIVE specification strongly advises one not to use two-way connecting roads, although two-way connecting roads are possible using the schema. The seventh connecting road 516 goes against this advice, but does not violate it (and, in practice, it is more likely that two one-way connecting roads would be defined). The fourth road 508 is not an incoming road to the junction 510 (even though its s-axis extends towards the junction 510), because it is a one-way road that only carries traffic away from the junction 510.

A connecting road with multiple lanes is used when lane changes are possible within the junction 510; if lane changes are not permitted, multiple single-lane roads would be used instead.

A “virtual” connection can also be described using a <connection> element without any connecting road. Virtual connections are limited to “virtual” junctions, which do not require a main road to be split up.

Links between lanes are described via link elements within the <lane> elements that describe those lanes, where predecessor and successor lanes are described in a similar manner to roads. In order for a first lane of a first road to be a predecessor or successor of a second lane of a second road, the second road must be a predecessor or successor of the first road. As the junction 510 is the successor of the first, second and fourth roads 502, 504, 508, these roads 502, 504, 508 have no direct successor roads; therefore, it is not possible for any of their lanes to have lane successors. Likewise, as the junction 510 is the predecessor of the third road 506, the third road 506 has no direct predecessor road; therefore, its lanes cannot have any predecessors. Within the junction 501, however, each of the connecting roads 512-5120 has both a direct successor road and a direct predecessor road; for example, the direct successor road of the fifth road 512 is the first road 502 and its direct predecessor is the third road 506. Consequently, lanes of the connecting roads 512-520 can be linked to lanes of both their predecessor and their successor roads. For example, the fifth road 512 would typically contain two positively-numbered side-lanes, 1 and 2. The side-lanes of Road 5 are not depicted in FIG. 5, but are shown in FIG. 6. The lane elements describing lanes 2 and 1 of Road 5 would, in turn, contain link elements, which indicate lane numbers “3” and “2” as their respective predecessors (and it is implicit that these are lanes of Road 5's successor, namely Road 1), and lane numbers “2” and “1” as their respective successors (implicitly referring to Road 5's successor, namely Road 3). A <connection> element also contains any lane links that apply to it (see FIG. 6 and the description below for further details).

There are many contexts in which it would be useful to determine a route through all or part of the road network 500 in terms of lanes. This is referred to herein as “microplanning”. The aim of micro planning is to determine one or more directed lane sequences (“micro routes”) that satisfy some given criteria (such as a current and target lane). Whilst it is often drivable side-lane sequences that are of interest, non-drivable sequences may be considered e.g. to route pedestrians.

For example, given a current lane and a target lane (the goal), an application might require, say, the shortest route from the target lane to the target lane, or all possible routes from the former to the latter. For example, suppose the current lane is Lane 2 of Lane Section 1 or Road 1, and the goal is Lane 1 of Road 3. The following lane sequence (Lane Sequence 1) is one possible route from the former to the latter:
((Lane 2, Lane Section 1, Road 1), (Lane 3, Lane Section 2, Road 1), (Lane 2, Road 5), (Lane 2, Road 3), (Lane 1, Road 3)).

For conciseness, the above syntax only includes Lane Section indices for roads with multiple Lane Sections, to avoid ambiguity. In practice, every OpenDRIVE road has at least one Lane Section and “(Lane M, Road M)” implies (Lane M, Lane Section 1, Road N), where Lane Section 1 is the single lane section defined in Road N (unless otherwise indicated).

That is, traversing onward from Lane 2 of Lane Section 1 of Road 1 to Lane 3 of Lane Section 2 of Road 1, entering the junction 510 at Lane 2 of Road 5, leaving the Junction at Lane 2 of Road 3, and then changing to Lane 1 of Road 3.

Another possible lane sequence (Lane Sequence 2) is:
((Lane 2, Lane Section 1, Road 1), (Lane 1, Lane Section 1, Road 1),
(Lane 2, Lane Section 2, Road 1), (Lane 1, Road 5), (Lane 1, Road 3)).

That is, starting in Lane 2 of Lane Section 1 of Road 1, changing to Lane 1 of the same lane section, moving into Lane 2 of Lane Section 2 of Road 1, entering the junction 510 at Lane 1 of Road 5 and leaving the junction at Lane 1 or Road 3.

Whilst it is relatively easy for a human with driving experience to determine such lane sequences,

FIG. 6 shows part of the road network 500 of FIG. 5, annotated with sections of OpenSCENARIO code that define certain elements of the road network.

Starting from any lane of any of the incoming roads 502, 506, 506, the <connection> elements within the junction describe all possible routes though the junction 510 (at the road level). For a given lane on a given road, obtaining a list of all routes through the junction would mean locating all of the <connection> elements that identify the road in question as an incoming road, via its road ID, and which also have a lane linked to the lane in question. To obtain further lane links, it would then be necessary to locate the <road> element of its connecting road, in order to identify the outgoing road (for the fifth road 512, the outgoing road would be the third road 506), and determine the lane linkage between the connecting road and the outgoing road.

A first code portion 602 contains a connection element (connection ID=0) that indicates the first road 502 (the road with ID 1) as an incoming road and the fifth road 512 (the road with ID 5) as a connecting road. First and second <laneLink> elements link Lane 3 of Road 1 (its incoming road) to Lane 2 of Road 5, and Lane 2 of Road 1 to Lane 1 of Road 5. A second portion of code 604 contains the <road> element describing Road 5 within the junction 510 (junction ID=0). A <link> element within the road element contains both <successor> and <predecessor> elements. The road link in the predecessor element indicated Road 1 as the predecessor to Road 5, which mirrors the lane links in the corresponding <connection> element (Connection 0). The successor element indicates the third road 506 (the road with ID 3) as successor to Road 5. A <lane> element is also shown within the road element for Road 5, which describes Lane 2 of Road 5 (other lane elements are omitted for conciseness); the lane element contains a link element, which in turn indicates Lane 2 as its successor and Lane 3 as its predecessor. To meaningfully interpret the lane links, it is necessary to consider the road link information; Road 1 is the predecessor to Road 5, therefore Lane 3 of Road 1 is the predecessor of Lane 2 of Road 5; Road 3 is the successor to Road 5, therefore Lane 2 of Road 3 is the successor to Lane 2 of Road 5. A third code portion 606 contains the road element describing Road 3. The junction 510 (junction ID=O) is indicated as the predecessor to Road 3, and a lane element is shown that describes Lane 2 of Road 3 (other lane elements are omitted for conciseness).

As can be seen from the above example, extracting a relatively basic piece of information —in this case, the direct route though the junction from Lane 3 or Lane Section 2 of Road 1 to Lane 2 of Road 3 —is fairly inefficient.

Moreover, for microplanning, it is not sufficient to simply consider lane links, as this would ignore other micro routes that involve lane changes. It is therefore necessary to consider lane changes separately. Lane numbering is useful here, because it allows adjacent lanes in the same driving direction to be identified. However, lane numbering is not necessarily determinative. For example, returning briefly to FIG. 5, it is not possible to move from Lane 2 of Road 2 to Lane 1 of Road 2 because the latter is non-drivable. Although not depicted in FIG. 5, additional lanes may be used to describe the boundaries of the road, such as border or shoulder lanes, or lanes which are only usable by certain forms of agent (such as bus or cycle lanes).

Moreover, OpenDRIVE accommodates bidirectional lanes, and it is, in principle, possible to change from a positively-numbered lane to a negative numbered lane, or vice versa, if the destination lane is bidirectional. That said, in this particular implementation, the topological index 411 (‘DirectedSideLaneGraph’) as exposed through the SQE API 403 does not support lane change transitions that cross the road center-line (even if the target lane were bi-directional). In any case, the topological index 411 guarantees that any available transition will be supported by consistent driving directions (a route will never be returned down a one-way street in the wrong direction).

### Lane Graph

FIG. 7 shows part of a directed side-lane graph 700 generated for the road network 500. The directed side-lane graph 700 is referred to simply as the lane graph 700 for conciseness. The lane graph 700 describes lane interconnections from Road 1 though the junction 510. As described above, the lane graph 700 is an in-memory data structure that serves as an index for topological queries.

The lane graph 700 is implemented in memory as a collection of vertex descriptors to refer to the vertices of the graph (the directed side-lane references) and a collection of edge descriptors to refer to links (directed edges) between them; each vertex descriptor is then associated with a collection of incoming edge descriptors and a collection of outgoing edge descriptors. These descriptors are separate from the publicly exposed descriptors shown in FIG. 4, but the vertex descriptors do correspond to the directed side-lane descriptors (that association is managed internally).

For example, first and second nodes 702, 704 correspond, respectively, to Lane 1 of Lane Section 1 of Road 1 and Lane 2 of Lane Section 2 of Road 1. An onward edge 706 indicates the topological relationship between those lanes, namely that the latter is an “onward” lane from the former (i.e. a vehicle can traverse from the former to the latter without performing a lane change maneuver). An edge descriptor is associated with the nodes 702, 704 that defines the directed edge from the former to the latter with an indication of edge type (“onward” in this case). A node or edge descriptor can be contained in a single memory address or multiple memory addresses (e.g. in a block of memory addresses).

The lane graph 700 is constructed by interpreting the code of the static layer 414. Note that edges of the lane graph denote driving direction. To determine onward edges, lane links need to be considered, but driving direction also needs to be considered.

Edges are also provided for left-right relationships. For example, third and fourth nodes 708, 710 are depicted, representing Lanes 3 and 1, respectively, of Lane Section 2 of Road 1. A right edge 711 from the second node 704 to the fourth node 710 represents the possibility of moving from Lane 2 to Lane 1 of that lane section via a right lane change maneuver. A left edge 709 from the second node 704 to the third node 708 represents the possibility of moving from Lane 2 to Lane 3 via a left lane change maneuver. The left and right edges 709, 711 are stored in memory as edge descriptors, with an indication of their respective types (“left” and “right”). This information is not provided in <link> elements of the underlying description, but is obtained from the structure of the road as explained above.

A fifth node 714 represents Lane 1 in the only road section of Road 5, which is an onward lane from Lane 2 in Lane Section 2 or Road 1. Therefore, an onward edge 712 is directed from the second node 704 representing the former to the fifth node 714 representing the latter.

As will be appreciated, there are various ways a graph structure of this nature can be encoded in memory, such that topological relationships within the road network 500 are encoded as in-memory pointers between nodes that represent road structure elements. Whilst FIG. 7 depicts a lane graph, a similar geometric index can be constructed at the road level, with nodes representing roads, and pointers representing topological relationships between the roads.

In the lane graph 700, a second lane is said to be connected to a first lane if there exists an edge from the first lane to the second lane (implying that it is possible to move from the first lane into the second lane). As indicated, this concept of “connections” in the lane graph is distinct from the concepts of links in OpenDRIVE.

Considering the microplanning query above, topological queries can be accommodated highly efficiently. For example, given a current lane and a goal lane, micro routes from the former to the latter can be easily determined as a set of paths through the lane graph 700 from the node representing the former to the node representing the latter.

Lane sections do not have explicit identifiers in OpenDRIVE. However, they are implicitly indexed by the order in which they appear in the applicable <Road> element. These implicit indices are used to reference Lane Sections within the SQE 402. Specifically, the SQE 402 uses a zero-based index of the lane-section in the road.laneso.lane_sectionso collection.

FIG. 7A shows further details of part of the lane graph 700. Each edge has an associated cost stored in association with it. For example, the cost may be contained in the edge descriptor describing that edge. For the sake of illustration, the figure shows costs 709C, 711C and 712C associated with the left, right and onward edges directed from the second node 704 to the third, fourth and fifth nodes 708, 710, 714 respectively. Costs for other edges in the graph are not shown, but each edge of the lane graph 700 is associated with a cost in this manner.

The costs take the form of distance penalties that facilitate a fast search for the shortest micro-route from one node to another. In practice, this search will be approximate. For a given lane sequence, the actual distance travelled will, in practice, have some dependence on driver (or other actor) behaviour, such as the timing of lane change maneuvers, the extent of lateral movement within a lane etc.. Nevertheless, it is possible to assign each edge of the graph 700 a cost that is generally representative of distance travelled.

When an onward edges in the directed side-lane graph 700 is traversed, a cost is incurred that is equal to the physical length of the source side-lane mid-line (measured from the beginning of the supporting lane-section). That is, for an onward edge from one lane to another, it is the length (longitudinal extent) of the former that is material. Thus, the distance penalty 712C associated with the onward edge from the second node 704 to the fifth node 714 depends on the length of Lane 2 in Lane Section 2 of Road 1. Conceptually, route planning from a given node (at the start of a route or along a route) begins at the start of the lane, as defined by driving direction. To reach an onward lane from the start of a current lane requires the given lane to be driven (or otherwise traversed) in order to reach the onward lane. Hence, to support this form of route planning, the cost of an onward edge from a current lane to an onward lane is given by the length of the current lane (not the onward lane), or any suitable function of the length of the current lane.

When a neighbouring edge in the lane graph 700 is traversed, a cost is incurred that is equal to the distance between the supporting side-lane mid-lines. That is, for a left or right edge, lateral distance is material. For example, the cost of a left or right edge from a current lane to a neighbouring (left or right) lane may be a lateral distance between the current lane and the neighbouring lane. The lateral distance need only be approximate and generally representative of the additional travel distance incurred by a lane change. Indeed, one aim is to prevent a cost-based search of the graph from returning routes with excessive left-right lane changes (e.g. switch back and forth between the same two lanes repeatedly), and to achieve this, any non-zero cost of sufficient magnitude may be used (because each ‘unnecessary’ left/right lane change adds to the overall cost).

The point at which the lateral distance is measured is arbitrary, and one option is to use the maximum of the inter side-lane mid-line distance at the start and the end of the supporting lane-section (to keep it symmetric). In this case, the distance penalty for a left/right edge is taken as the lateral separation between the current lane and the neighbouring lane (or some function thereof) at the start of the current lane or the end of the current lane (whichever is greater). Ideally one might want to use something more representative of any excess arclength introduced by making the lane-change, but the simpler heuristic it is sufficient for the current purposes. In any event, as noted, any lateral distance penalty sufficient to prevent repeated or unnecessary left/right lane changes may be sufficient.

It will be appreciated that distance-based costs can be constructed in other ways, and that the exact choice will be implementation-specific. In the context of a route planning query, distance-based costs need only be generally representative of travel distances associated with lane changes (in the broad sense), with the aim of finding an approximate shortest route (in the geometric sense) between any two given nodes of the graph 700. Other forms of cost may also be defined to support other types of topological query. In this context, although the query and the lane graph 700 are topological in nature, the costs are based on lane geometry. Geometric costs allow geometric information to feed into topological queries without compromising runtime performance.

As noted, one example of a topological query at the SQE API 403 is a route-planning query that provides descriptors 423 of a desired start lane and a desired end lane. In order to respond to this query, a depth-first search is performed, taking into account the edge costs, with the aim of finding the lowest-cost route (lane sequence) from the start lane to the end lane. This will not necessarily be the route with the fewest lane changes; although the query is topological in nature, the costs are based on lane geometry. Although the costs generally discourage lane changes, it is the overall cost that matters. For example, in a road with high curvature, a lane closer to the center of curvature may be materially shorter (longitudinally) than a lane further from it (one concrete example being a roundabout; the innermost lane of a roundabout may be significantly shorter that the outermost lane). In this case, the additional penalty incurred by one or more left or right lane changes may be less the “saving” gained by choosing a shorter lane closer to the center of curvature.

FIG. 8 shows a second lane graph 800 for a road network that includes a bidirectional lane 802. The bi-directional lane 802 is represented by two separate nodes 804A, 804B within the lane graph 800 (one for each driving direction or, more generally, for each direction of traversal). For the purpose of route-planning and topological querying more generally, these nodes 804A, 804B are independent, having different incoming/outgoing edges, and thus different topological relationships to other nodes in the graph. This “splitting” of the bidirectional lane means the lane graph 800 can be constructed to prevent lane changes that would break driving rules associated with the network. In the example shown, Lane 1 is a single direction lane that permits a first driving direction (bottom to top on the page as shown), whereas Lane −2 is a single direction lane that only permits the opposite driving direction (second driving direction, which is top to bottom as shown). The bidirectional lane is Lane −1, supporting both driving directions. When driving in the first driving direction, it is permitted to change between Lane 1 and Lane −1, but not into Lane 2; Likewise, when travelling in the opposite driving direction, changes between Lane 2 and Lane 1 are permitted, but not between Lane 1 and Lane −1. These restrictions are captured in the structure of the lane graph 800: node 808 represents Lane −2, and node 804A represents bidirectional Lane −1 in the second driving direction, with edges between those nodes (in both directions) representing permitted lane changes between Lane −1 and Lane −2 in the second driving direction. Node 806 represents Lane 1, and is not directly connected to node 804A. Instead, node 804B represents Lane −1 in the first driving direction, with edges between node 806 and node 804B (in both directions) representing permitted lane changes between Lane 1 and Lane −1 (with no direct edges between node 804B and node 808). Starting from Lane 1, it is therefore possible to find a route that involves moving to Lane −1, as there exists an edge from node 806 to 804B. However, it is not possible to then move from Lane −1 into Lane −2, because no such edge exists from node 804B to node 808. Likewise, starting from Lane −2, it is possible to find a route that involves moving from Lane −2 to Lane −1, as there exists an edge from node 808 to node 804A. However, it is not possible to then move from Lane −1 to Lane 1, as no such edge exists from node 804A to node 806.

Note that the example depicted in FIG. 8 requires a centerline 801 of the road to be crossed in order to move from Lane 1 to Lane −1. This is considered a high-risk maneuver, and certain implementations of the SQE 402 exclude such maneuvers altogether. In such implementations, the lane graph 800 excludes any edge that results in crossing of a road centerline. In this case, node 804B would be omitted, the bidirectional Lane −1 would be represented by only a single node 804A, and the possibility of changing from Lane −1 to Lane 1 would not be captured in the lane graph 800. A new API could be introduced to handle such high-risk maneuvers that are excluded from the lane graph 800, to make any such maneuver explicit in any resulting code. Such an architecture would, by design, separate such maneuvers from other “normal” maneuvers considered by the SQE 402.

A situation can arise when a bidirectional lane may be entered by traffic flowing in either direction without crossing the center line. For example, a bi-directional lane connecting two two-way roads can be entered at either end.

### Road Partition Index

Returning briefly to FIG. 5, OpenDRIVE uses continuous, parameterized mathematical functions to describe road and lane geometry (and road/lane structure more generally). This presents challenges for geometric indexing and efficient querying, as set out below.

At a minimum, a road must have a road reference line that is described by a pair of scalar-valued functions (x(s),y(s)) or, more likely, a set of such function pairs having different supports along the road, as a function of inertial coordinates (x,y). Exactly how this is done depends on the character of the curve. For lines, arcs and spirals the curves are defined implicitly by specifying the characteristic properties of the curve (e.g. the curvature, etc.), but for the parametric cubic curves it is done explicitly. Currently, the available function classes for describing road reference lines in OpenDRIVE are: straight line, spiral, arc, polynomial and parametric polynomial. Polynomials and parametric polynomials can be defined up to third order (cubic). A function can change because the function class changes (e.g. from straight line to spiral), or if the function class does not change but at least one parameter changes (one example being two polynomial functions with different parameters). For example, on some s-coordinate interval s=[0,s1), the road reference line might be described by a first, linear (straight line) function, parameterized by some starting coordinates (x0, y0) at s=0 and a gradient (slope) of the line, ending coordinates (x1, y1) at s=s1. On a subsequent s-interval, [s1, s2), the road reference line might be described by a second, spiral function starting at (x1, y1) in inertial coordinates (s=s1 in road coordinates), continuing to (x2, y2) (s=s2), and described by start and end curvature parameters at s1 and s2. Then, on subsequent interval [s2, s3), the road reference line might be described by a third arc function parameterized by a constant curvature, or some other third function such as a cubic polynomial y=a +b*x+c*x^{A} 2+d*x^{A} 3, described by parameters (a,b,c,d) (in fact, OpenDRIVE is more flexible, and allows polynomials to be defined in local (u,v) coordinates, rotated relative to inertial (x,y) coordinates, for describing roads with arbitrary rotation in the world; the following description and the figures refer to polynomials in (x,y) for simplicity, but apply equally to chosen (u,v) coordinates). The intervals [0,s1), [s1,s2), [s2,s3) are the supports (in the mathematical sense) of the first, second and third functions respectively, with s1 and s2 being the points along the road at which the road reference line function changes. Such a change can occur at any arbitrary point along the road.

In addition, further functions are used to describe the road/lane geometry relative to the road reference line. One such function is a lane width function, which defines the outer boundary of a lane relative to its inner boundary (which, in turn, could be the outer boundary of another lane or the road centerline). For example, although not readily visible, in FIG. 5, Lane −1 in Lane Section 2 of Road with ID=2 might have a slightly increasing width, and be described by three side-lane width functions: a first constant width function on a first s-interval, a linearly increasing width function on a second interval, and a second constant width function on a final s-interval. At the same time, the road reference line 505 itself might be described by multiple functions (e.g. a straight line function then a cubic function), whose supports have no particular relationship to the supports of the lane width functions. Other functions that may need to be considered include a center offset function, defining an offset between the road reference line and the road centerline (the centerlane in OpenDRIVE terminology).

The above considerations also extend to non-geometric functions. For example, at some point along a marked lane boundary, the form of marking might change (e.g. from a solid line to a broken line). In some implementations, this may be treated (for the purpose of indexing) as a change in lane marking function. In other implementations, non-geometric function may be considered separately; for example, a first road partition index may be constructed for lane geometries and a second road partition index (with different partitioning) may be constructed for some other property or properties of the road/lanes (such as markings, speed limits etc.). In the examples described below, the primary reason for a road partition is to allow the efficient positioning of points either on the lane-boundaries or within the lane itself, and in this context, it may be desirable to consider only those functions describing lane geometry in the road partition index 407. Alternatively or additionally, one might choose to partition the road in different ways to support other tasks that are largely independent from that task (such as computing lane markings or speed limits etc.). Thus, one or multiple road partition indexes may be constructed that are task-specific to varying degrees (each is constructed according to the same principles, but on different function sets, and thus with different partitioning in general as defined by the supports of their respective function sets).

A separate road partition index is generated for every road in a road network. Every road identifier is associated with a “RoadLookups” instance and that instance manages a “RoadPartition” instance. These are all initialised on construction of a ScenarioQueryEngine instance (and are immutable thereafter).

The road partition index 407 of FIG. 2 is structured with the above considerations in mind. OpenDRIVE is considered by way of example, but the road partition index can be usefully applied to road having multiple components (e.g. reference line, center-lane/center-line, lane(s)/side-lane(s)), where each component of the road is described by at least one function that can change along the road, independently of the other component(s) and/or function(s) (at least to a degree).The number and/or nature of the components may or may not also change along the road (e.g. in open drive, the number of components can change as the number of side-lanes can change). As such, there is generally no particular relationship or alignment between the respective supports of those functions, and those supports can overlap more or less arbitrarily with each other. The road partition index 407 may take into account all possible functions that describe a road (e.g. all required geometric function, plus any non-geometric functions such as lane markings etc.) or only a subset of functions (e.g. geometric functions only, or some subset of geometric functions depending on the ultimate application).

A lane width function describes the geometry of an outer lane boundary relative to its inner boundary. OpenDRIVE also allows the use of lane boundary functions, as an alternative to lane width functions, to describe a lane boundary (border) directly (which translates to slightly different curve evaluation strategy).

The principle of the road partition index 407 is as follows. Given a set of functions under considerations, the road is partitioned such that, within each road part, the subset of functions describing that road part do not change. This means that the number of functions does not change, and the type and the parameters of each of those function(s) remains constant within the road part.

In other words, a road-part is an element of a road-partition, which in turn is a sequence of s-intervals that cover the entire length of the road such that, in each interval, the functional structure of the entire road cross-section remains fixed (with respect to the set of functions under considerations).

FIG. 9 shows a simplified example of a road partition index 407 constructed on a road 900 (Road M) shown towards the top of the figure. In this example, only the road reference line and side-lane border functions are considered, which may be sufficient for some applications and an over-simplification for others. It will be appreciated that the described techniques can be readily extended to incorporate additional functions and/or road components. The road 900 has, initially, a single lane (Lane −1) in the s-interval [s0,s2) in a first lane section. At s2, the first lane section begins, and a new lane section with two lanes (Lanes −1 and −2) begins.

In a first interval [s0,s1), only a single lane exists (Lane −1), and its outer border is described by a first, constant function 902. In a second interval [s1, s2), there is still only a single lane, but its outer border is now described by a second, polynomial function 904. At s2, the second lane section begins, with two lanes. Lane −2 is the onward lane from Lane −1 in the previous lane section, and in the interval [s2, s3). The outer border of Lane −2 is described by a third function 906 (also polynomial), and the outer boundary of Lane −1 is described by a fifth function 910 (polynomial, and gradually increasing from zero from s2). At s3, a change occurs in the function describing the outer border of Lane −2; in the interval [s3, s5], that boundary is now described by a fourth, linear function 908. Note that no change occurs in the boundary function of Lane −1 at s3; it is only at s4 that the boundary function of Lane −1 changes (to a sixth, constant function 912, on the interval [s4, s5]). Likewise, no change in the boundary function of Lane −2 occurs at s4. Whilst FIG. 9 considers boundary functions, the same principles apply in the case that width functions are used instead to describe the lane borders.

Each function 902-912 is stored in memory. In practice, this means storing the parameter(s) of the function, with some indication of the form and type of function (whether explicit or implicit). Each function may be stored at one or multiple memory addresses.

The functions of FIG. 9 are summarized in Table 4 below. Unless otherwise indicated, the “type” of the function refers to the physical attribute(s) it describes, with “class” and “form” referring, respectively, to its general and specific mathematical properties.

TABLE 4
Lane border functions of FIG. 9.

| | Describes | Support | Type | Class | Params. | Mathematical form |
|---|---|---|---|---|---|---|
| First | Outer | [s0, s1) | Boundary | Constant | a0 | border (ds) = a0 |
| function | border of | | | | | |
| 902 | Lane −1 in | | | | | |
| | Lane | | | | | |
| | Section 1 | | | | | |
| Second | Outer | [s1, s2) | Boundary | Polynomial | a1, b1, | border (ds) = |
| function | border of | | | | c1, d1 | a0 + b1*(ds) + |
| 904 | Lane −1 in | | | | | c1*(ds)\hat{ }2 + |
| | Lane | | | | | d1*(ds)\hat{ }3 |
| | Section 1 | | | | | |
| Third | Outer | [s2, s3) | Boundary | Polynomial | a2, b2, | border (ds) = |
| function | border of | | | | c2, d2 | a2 + b2*(ds) + |
| 906 | Lane −2 in | | | | | c2*(ds)\hat{ }2 + |
| | Lane | | | | | d2*(ds)\hat{ }3 |
| | Section 2 | | | | | |
| Fourth | Outer | [s3, s5) | Boundary | Constant | a3 | border (ds) = a3 |
| function | border of | | | | | |
| 908 | Lane −2 in | | | | | |
| | Lane | | | | | |
| | Section 2 | | | | | |
| Fifth | Outer | [s2, s4) | Boundary | Polynomial | a4, b4, | border (ds) = |
| function | border of | | | | c4, d4 | a4 + b4*(ds) + |
| 910 | Lane −1 in | | | | | c4*(ds)\hat{ }2 + |
| | Lane | | | | | d4*(ds)\hat{ }3 |
| | Section 2 | | | | | |
| Sixth | Outer | [s4, s5) | Boundary | Constant | a5 | border (ds) = a5 |
| function | border of | | | | | |
| 912 | Lane −1 in | | | | | |
| | Lane | | | | | |
| | Section 2 | | | | | |
| Road | Road | [s0, s5] | Road | Straight | (x0, y0) | See below |
| ref. line | reference | | Reference | Line | hdg | |
| function | line | | Line | | | |

The point at which the function changes for a given attribute of the road (e.g. lane border) is described as a change point herein, and the change points between different attributes (e.g. lane borders) exhibit longitudinal misalignment to the extent their function supports are misaligned. In the example of FIG. 9, the attributes are lane borders: specifically, the outermost lane border extending from s0 to S5, with additional change points at si1, s2 and s3 (first border); and the adjacent lane border (inner border of Lane −2 and outer border of Lane −1) from s2 to s5, with an additional change point at s4 (second border 922). The change points si1 and s3 of the first border 920 and the changepoint s4 of the second border 922 exhibit mutual longitudinal misalignment, with the road being partitioned at every change point (s0, s1, s2, s3, s4, s5) as per Table 9.

Each attribute is said to be described by a describing function, whose functional form changes at the change points of that attribute. Thus, the first, second, third and fourth functions 902, 904, 906, 908 constitute different functional forms of the describing function of the first lane 920, and the fifth and sixth functions 910, 912 constitute different functional forms of the describing function of the second lane border 922.

In FIG. 9, “ds” denotes relative s-coordinates, measured from the start of the element in question. Thus, for a function beginning at s2, ds=0 corresponds to s=s2. To put it another way, for a given function, ds=0 denotes the start of that function's support. Note, in OpenDRIVE “ds” is used specifically as a track-position increment measured relative to the beginning of a lane-section boundary (or a lane-offset or lane-width function definition boundary). For the geometries that support the road reference curve, there is an added complexity, with an intermediate correspondence between the track-position s (measured from the beginning of the supporting road) and the parameter of the underlying function. This added complexity is not considered directly relevant in the present context and is therefore ignored in the following examples for ease of illustration.

In the OpenDrive schema, a function describing some attribute of a side-lane necessarily changes whenever a new lane section begins, in the sense that the function for each lane has to be defined from the start of the lane section. The function may or may not change in a mathematical sense (e.g. in the example of FIG. 9, a single polynomial function could, in principle describe the outermost lane border in the interval [s1, s3); however, in OpenDRIVE that function needs to be re-defined at the start of the new lane section, with ds=0 now denoting the start of the new function and the new lane section). In the current implementation, this is treated as a change in function, in order to match the OpenDRIVE schema. As such, the second and third functions 904, 906 are stored separately (and their parameters will be different, because they are defined in terms of “ds” rather than “s”). However, such circumstances may be treated differently in other implementations and/or schemas (e.g. with a single function used to describe the outermost boundary between s1 and s3).

For simplicity of illustration, it is assumed that the road reference line function does not change in the interval [s1,s5]. The road reference line is thus described by a single additional function (not depicted), which is a straight line function defined by starting coordinates (x0,y0) at s0 (s0=0, the start of the road, in this example), and gradient (hdg), such that the (x,y) coordinates on the road reference line of a point s in [s0, s5] are given by:

$$x = x 0 + ds / sqrt ( 1 + {hdg}^{∧} 2 ) ;$$

$$y = y 0 + ds / sqrt ( {hdg}^{∧} ( - 2 ) + 1 ) .$$

In this particular example, ds=s, as the start of the road, s=0, is the same as the start of the single road reference line function.

The road partition index 407 is constructed as follows. Firstly, the road 900 is partitioned in the above sense, based on a set of functions under consideration (reference line and boundary functions). The road parts are chosen so that no function change occurs in any road part. In this example, this requirement implies a minimum of five partitions, summarized in Table 5, where bold font is used to denote any change that requires a new road part. PP6T,

TABLE 5
Example road partitioning for Roam M of FIG. 5.

| | Components | Functions |
|---|---|---|
| S0 = | Road reference line; | Road ref. line function; |
| [s0, s1) | Lane −1 | First function 902 |
| S1 = | Road reference line; | Road ref. line function; |
| [s1, s2) | Lane −1 | Second function 904 |
| S2 = | Road reference line; | Road ref. line function; |
| [s2, s3) | Lane −1 | Third function 906 |
| | Lane −2 | Fifth function 910 |
| S3 = | Road reference line; | Road ref. line function; |
| [s3, s4) | Lane −1 | Fourth function 908 |
| | Lane −2 | Fifth function 910 |
| S4 = | Road reference line; | Road ref. line function; |
| [s4, s5] | Lane −1 | Fourth function 908 |
| | Lane −2 | Sixth function 910 |

Table 5 assumes the road reference line function does not change. If the road reference line function does change, this would require at least one additional road part (unless the change in road reference line function happened to coincide with the change in one of the lane boundary functions, but as noted, there is no requirement for the function supports to align in this way).

The described implementation adopts the minimum required partitioning (a lane part can be arbitrarily long, provided none of the functions change). Sub-parts are considered below, in the context of the line segment tree 452a, but are not considered in the road partition index 407 in this example. Other implementations may increase the extent of partitioning (e.g. to divide up longer intervals even though no function change occurs), however this is avoided in the present example: the aim is for each entry of the road partition index to contain as much geometric information as possible, subject to the constraint that no function of interest changes within any road part.

The road partition index 407 has an entry for each road part, which contains a reference(s) to the subset of function(s) that describe that road part. Each function reference identifies the location(s) at which the function in question is stored. Thus, in FIG. 9, the road partition index 407 is shown to have five entries, for the five road parts and their respective functions listed in Table 5. This implies a degree of duplication: for example, the entries for the intervals S3 and S4 are denoted by reference numerals 407A and 407B respectively, and each contains a reference to the third function 908 describing the outermost lane boundary. Note that it is the function references that are duplicated in the road partition index 407; the functions themselves form part of the StaticLayer document itself (containing the static layer 414) and the function references allow them to be located in the document (or the in-memory representation thereof), e.g. via the second API 405. This reduces the required memory overhead, whilst still providing a significant performance improvement at run-time.

For example, each entry of the road partition index 407 may take the form of a key-value pair, the key being some identifier of the road part (e.g. the interval defining the road part, or some other identifier mapped to that interval), and the value being the function reference(s) for that road part.

A query on the road partition index 407 provides a road part descriptor, allowing the corresponding entry for that road part to be located. By design, at run time, only the single set of functions needs to be considered, and each function is guaranteed to remain the same (as in the form of the function does not change), allowing the geometry (or attributes more generally) of the road part to be computed highly efficiently using the referenced function(s).

### Spatial Indexes

Each spatial index covers the entire static layer 414, which simply requires the road identifiers to be unique within the static layer 414.

In addition to the road partition index 407, e lane part bounding boxes are indexed (in the box tree 450), as are a set of line-segments that lie on the inner and outer lane-boundaries of each side-lane part (inner and outer boundaries are separately indexed, in the inner and outer line segment trees 452a, 452b respectively, as outlined above). As described above, a lane part (or more specifically a side-lane part) is the intersection of a side-lane with a road part (in the above sense).

Every geometry (either line-segment or bounding box) that is placed into the spatial index is associated with a lane bundle, which is a data structure containing references to the supporting side-lane, the supporting road-part and any other supporting lookups tables.

The road partition index 407 is used to compute the bounding boxes and the line segments held in the spatial indexes 450, 452a, 452b. The indexes 450, 452a, 452b are also constructed in a way that is complementary to the road partition index 407: certain types of internal or external query on one of the spatial indexes 450, 452a, 452b return an internal or external response that links back to the road partition index 407 to allow further querying on the road partition index 407. The spatial indexes 450, 452a, 452b are constructed to allow such responses to be generated quickly and efficiently.

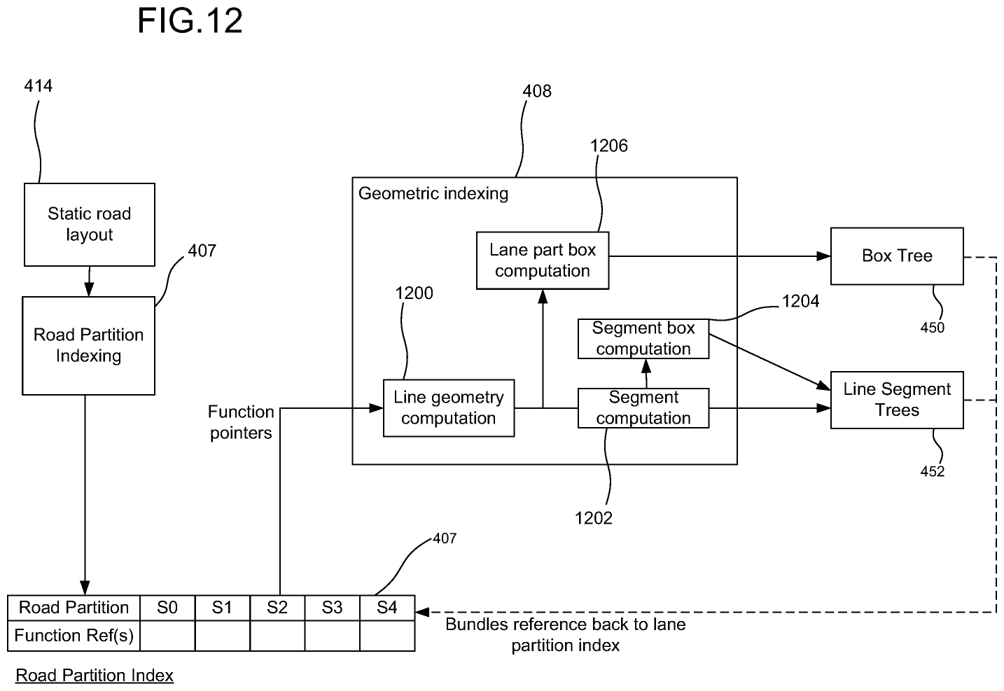

FIG. 12 broadly depicts how a box tree 450 and the line segment trees (collectively 542) are generated from the road partition index 407. As part of the geometric indexing component 408, a line geometry computation component 1200, a segment computation component 1202, a segment box computation component 1204 and a lane box computation component 1206 are shown.

The s-interval of a road part is one form of road part ID. It may be convenient to pass the intervals that correspond to individual road parts to/from the API 403, and/or internally, essentially using the intervals as road part descriptors. This provides both a refined estimate of “location” when returned from an API and provides a key that can be used to accelerate queries when passed to an API. Since the road-partition is stored as a collection of road parts that is ordered in terms of the lower bounds of the corresponding track-position interval it is also possible to simply use a given track-position to locate the corresponding road part efficiently. Thus, a single track coordinate within the interval of a road part can also serve as a road part identifier in the present context. The introduction of a higher level of abstraction, in the form of a discrete set of road-part descriptors, used internally and/or passed externally to/from the API 203, may also be beneficial.

### Line Segment Trees

FIG. 10A depicts an example inner boundary index 452a, in the form of a line segment tree, for the road 900 of FIG. 9, together with a schematic illustration of certain geometric elements stored in the index 452a.

FIG. 10D depicts an example outer boundary index 452b, in the form of a line segment tree, for the road 900 of FIG. 9, with a similar depiction of the corresponding road geometry.

The following description focuses mainly on the inner boundary tree 452a. As will be apparent, most of the description applies equally to the outer boundary tree 452b.

The inner boundary tree 452a has leaf nodes and non-leaf nodes, with edges corresponding to parent-child relationships. At the bottom of the tree 452a, each leaf node represents an individual line segment that approximates a portion of a single inner lane boundary within a given s-interval interval. Following similar principles to the road partition index 407, for any-given leaf node, the s-interval of its line segment is fully contained within a road part (that is to say, no line segment interval spans multiple road parts). At the leaf node level, a line segment could span an entire road part or a sub-interval thereof, but is always contained within a single road part.

Each non-leaf node is a parent node having one or more child nodes (which could be leaf or non-leaf nodes). Each parent node contains a bounding box, which is the bounding box containing all of the bounding boxes of its child nodes (for non-leaf children) or the line segments of its child nodes (for leaf children).

Referring to FIG. 12, each line segment tree is constructed from the road partition index 407 as follows. The line geometry computation component 1200 computes the road and lane geometry for each road part, using the function(s) referenced in the corresponding entry of the road partition index 407. The interval of the road part is subdivided. Preferably, the size of each sub-interval is determined in dependence on the road geometry, and in particular based on road and/or lane curvature. In each sub-interval, all inner/outer boundaries (as applicable) are approximated by a straight line segment (computed from the line geometry by the segment computation component 1202). Thus, for highly curved boundaries, a shorter sub-interval is needed to maintain a given level of accuracy in the approximation. The same sub-intervals are used for every boundary, and in this case the size of the sub-intervals may, for example, be determined by the boundary with the highest curvature (e.g. in that case, for a single side-lane road with an essentially straight centerline and but a curved outer boundary, the centerline and the road reference line are subdivided on the same sub-intervals, whose size is determined by the curvature of the outer boundary). The segment box computation component 1206 computes a bounding box around each computed line segment, as well as parent bounding boxes. Each bounding box is a rectangle that is aligned with the x and y axes of the inertial coordinate system, and is thus fully defined by the coordinates of two diagonally opposite corner points.

Returning to FIG. 10A, at the bottom of the tree, leaf nodes representing line segments L0, . . . , L3, L7 and L8 are depicted, which are children of a non-leaf node representing bounding box A4. Line segments L0, L1 and L2 lie approximately on the inner boundary of Lane −2 in Lane Section 2, L3 lies approximately on the inner boundary of Lane −1 in the same lane section (defined by the road center lie), and L7 and L8 lie on the inner boundary of Lane −1 in Lane Section 1 (also defined by the road center line). As will be appreciated, the tree 542a may contain many more leaf nodes in practice, with different parent nodes. For conciseness, the node representing a given line segment Ln or bounding box An may be referred to as the node Ln or the node An.

A lane may have zero width but, in practice, lane widths tend to be zero only at one track-position (at either the first or last point in a lane-section). Theoretically, however, the inner and outer boundaries of a side-lane part may effectively coincide at locations other than at the beginning or the end of a part. In practice, this can likely be essentially ignored (that said, special account of that fact may be taken when building the closed boundary of a side-lane part, e.g. for use in a final containment test; if the width is effectively zero, the point that lies at the beginning (or the end) of the inner and outer lane boundaries is not duplicated). Alternatively, it would be a relatively straightforward refinement to identify and disregard lane portions of zero width, if needed in a particular context.

As discussed, each leaf node contains a bundle for a lane part. Note that, although each line segment is computed within a sub-interval of a road part, the bundle references the entire lane part to which it belongs (in terms of a lane ID and a road part ID that links back to the corresponding entry in the road partition index 407). Responses to queries are also returned in terms of descriptors of whole road parts. Externally, the division into sub-intervals is “invisible”; the aim of a query on the line segment tree 452a is generally to find an entire road or lane part satisfying some geometric query, and the further division into sub-intervals is simply to allow such queries to be answered both quickly and with reasonable accuracy.

The lane ID in a leaf node identifies the lane having the inner border on which its line segment lies (thus, lane ID=−1 for line segments L8, L7 and L3 lying on the inner border of the lane with ID −1, with the lane section defined implicitly in the reference to the corresponding road part; lane ID=−2 for line segments L2, L1 and L0, lying on the inner border of Lane −2).

As such, there is significant duplication of references/bundles across the leaf nodes, with potentially many leaf nodes referencing the same road part in the road partition index 407. Note, it is the references to the corresponding entry in the road partition index 407 that are duplicated at the leaf level of the line segment tree 452a, as opposed to the function references (separately, as noted, function references are also duplicated across the road partition index 407, to the extent the corresponding functions span multiple road parts).

The parent node A4 stores the bounding box A4, which in turn bounds all of its children's line segments L0, . . . , L8.

A grandparent node representing bounding box A5 is a direct parent of the node A4 and a second node representing bounding box A3 (in turn defined by its child nodes' line segments, which are not depicted). Bounding box A5 bounds the bounding boxes A3 and A4 of its direct children.

The example of FIG. 10A is highly schematic.

At the higher levels of the tree, there is no particular correlation between the structure of the tree and the structure of the road 900. Leaf nodes can be grouped together arbitrarily, and there is nothing to prevent a parent node from spanning multiple road parts at any level of the tree other than the leaf level, as leaf nodes contained within different road parts can be grouped under the same direct parent. Nearby leaf nodes should generally be grouped together, to ensure meaningful parent bounding boxes, and best performance is generally achieved with a reasonably balanced tree. Any suitable form of tree data structure can be used, including “self-balancing” structures that can determine parent/child relationships dynamically as the tree is built.

FIG. 10B shows bounding boxes (generally denoted An) and line segments (generally denoted Ln) that might be stored for a more realistic road geometry, for three levels of a tree (leaf level, plus two non-leaf levels). Here, “A” denotes a bounding box of the entire index (the outer limits of the whole index).

FIG. 10C shows an expanded view of the line segments stored at the leaf level. The road is shown to have multiple inner boundaries, and it can be seen that the same sub-intervals are used for every boundary. In the region denoted 1000, the curvature of two outermost boundaries increases briefly as the width of one of the lanes increases. This results in smaller sub-intervals for all lane boundaries (including the boundaries that remain essentially straight).

FIG. 10D shows an example outer boundary tree 452b constructed according to the same principles, but on outer lane boundaries rather than inner lane boundaries. Here, leaf nodes are shown representing line segments L1 and L2 on the outer boundary of Lane −1 (which also appear in the inner boundary tree 452a —see below), as well as line segments L9, L10, Li1 on the outer boundaries of Lane −2. As before, each leaf node contains a bundle referencing the entire lane part to which its line segment belongs, and the ID of the lane having the outer border on which the line segment lies.

Outer lane boundaries are excluded from the inner boundary tree. In practice, most borders serve as an inner boundary to one lane and outer boundary to a neighbouring lane. Thus, in general. only the two outermost boundaries of the road are excluded for a given lane section. The same principles apply to the outer boundary tree 452b of FIG. 10B. In this case, generally, only the centerline is excluded as it is not an outer border of any lane. Hence, in practice, most lane boundaries are duplicated across both line segment trees 452a, 452b. However, the line segments themselves are associated with different bundles in the two trees 452a, 452b.

The centerline does, however, serve as the inner boundary of both Lane 1 and Lane −1 in the depicted two-way road, and the line segments of the center line are therefore duplicated in the inner boundary tree for Lane 1 and Lane −1. This duplication arises because a filter may cause one or other of those lanes to be effectively ignored leaving only one of the boundaries intact. A filter can be constructed in terms of a predicate (or a combination of predicates).

Referring to FIGS. 10A and 10D, the line segments L1 and L2 lie on the border between Lane −1 and Lane −2, which is the inner boundary of Lane −2 and the outer boundary of Lane −1. In the inner boundary tree 452a, the corresponding nodes contain the lane ID −2, because those line segments lie approximately on the inner border thereof. By contrast, in FIG. 10D, the corresponding nodes of the outer boundary tree 452b contain lane ID −1, because those line segments L1, L2 lie approximately on the outer boundary thereof.

FIGS. 10E and 10F show an example of parent boxes and leaf-level line segments stored at three levels in a more realistic outer boundary index, for the same road as FIGS. 10B and 10C.

### Box Trees

FIG. 11A shows an example box tree for the road 900 of FIGS. 10A and 10D. The box tree is constructed according to somewhat similar principles, although it is generally simpler in its construction. Each leaf node represents a whole lane part (the intersection of a lane and a road section, as before), and contains a bounding box for that road part. Leaf-level bounding boxes R1, R2, R3 are depicted, with corresponding leaf nodes in the box tree 450. Each leaf node contains a similar bundle, comprising the lane ID of the lane it bounds, and a reference to the corresponding road section in the road partition index 407.

Leaf nodes can be grouped under a common parent node more or less arbitrarily, based primarily on proximity to each other and an overall aim of balancing the tree 450. Each parent node contains a bounding box, which bounds the bounding boxes of its children. In this case, both leaf and non-leaf nodes contain bounding boxes, but the principles are otherwise similar to the line segment trees 452.

A direct parent node of the depicted leaf nodes represents bounding box R5, which in turn bounds the bounding boxes R1, R2, R3 of the child leaf nodes. Node R5 is, in turn, a child of the node representing bounding box R7. Node R7 is additionally a direct parent of nodes representing bounding boxes R4 and R6, and the bounding box R7 bounds all of R4, R5 and R6.

FIG. 11A is highly schematic, and FIGS. 11B and 11C show more realistic boxes that may be stored at three levels of a box tree (level 3 being the leaf level). The bounding boxes will generally have a degree of overlap at every level, including the leaf level. In almost all cases, a leaf-level bounding box will include one or more regions outside of the lane part in question.

Referring to FIG. 12, the lane part bounding boxes at the leaf level of the box tree are computed by the lane part box computation component 1206, based on the computed line geometry.

### Containment Queries

FIG. 13 illustrates how a box tree 450 may be used to answer a containment query 1300 in two phases. The containment query 1300 is received at the SQE API 402, and contains (in this example) a specified (x,y) point. A containment query may be type-specific or non-type specific. A type-specific containment query specifies a lane type via one or more lane flags set in the containment query 1300.

For a type-specific query, a filter is initially applied to the box tree 450, to filter-out nodes other than those of the specified type. The result is a filtered sub-tree, on which the query is then run. The following description refers to queries on the box tree 450 and it will be appreciated that, in the case of a type-specific query, the relevant description applies to a filtered version of the sub-tree obtained by applying an active predicate(s).

For a non-type specific containment query 1300, if the point (x,y) is contained within a lane part, a response 1302 returns a descriptor of the containing lane part; otherwise a null result is returned. For a type-specific containment query, a null response is returned if (x,y) is not contained in any lane, but also if (x,y) is contained in a lane that does not match the specified lage flag(s); if (x,y) is contained in a lane of the specified type, a descriptor of the containing lane part is returned.

The example of FIG. 13 assumes that the point (x,y) lies within the lane part (lane ID=2, road part=[s2, s3) depicted in FIG. 11A. Steps 1304, 1306 and 1308 are performed in the first phase. At step 1304, top-level bounding boxes are assessed, and it can be quickly determined that (x,y) lies within the top-level bounding box R7 (1304). From this point on, only children of node A7 need to be considered. From only the child nodes of node R7, it can be quickly determined that (x,y) lies within bounding box R5; hence, only the children of node R5 need to be considered at the next level down. Of those child nodes, it can be quickly determined that (x,y) lies within the bounding box R2, thus terminating the first phase at leaf node R2. In the second phase, the bundle stored in node R2 is used to perform an intermediate, internal query on the road partition index 407, to obtain (step 1310) the set of function(s) required to compute the geometry of the lane in question (Lane −2 in road part S2=[s2, s3)). That geometry can now be computed (step 1312) to any desired degree of accuracy and, in turn, the computed geometry is used to definitely answer the containment query 1300. The accuracy level may, in some implementations, be specified in the query itself 1300 to allow a developer to set a desired trade-off between accuracy and performance. Note, this second phase does rely on pre-computed geometries, nor does it use the geometric information in the box tree 450 (at this point, the box tree 450 has served its purpose, by providing the lane ID and the reference to the required road part). The second phase is necessary, because the first phase is insufficient to conclude that the point (x,y) lies in Lane −2 of road part S2 (it could lie within the bounding box R2, but in a region outside of the lane). The result of the first phase is therefore at least one “candidate” lane part, which might contain (x,y).

It will be appreciated that the road 900 of FIG. 11A is highly simplified. In particular, the orientation of the road reference line is such that none of the bounding boxes overlap, which is unlikely in practice. FIGS. 11B and 11C are more realistic. As is evident from those figures, in practice a point (x,y) might be contained in multiple bounding boxes, in a region of overlap between those multiple boxes, such as the boxes labelled R18 and R19 in FIG. 11C. This would result in multiple candidate lane parts at the end of the query, each of which needs to be considered for containment in the sameway. It is not guaranteed that (x,y) is contained in any of the candidate lane parts, but it is guaranteed that (x,y) is not contained in any other lane part.

Whilst the above considers lane parts, a containment query could also be performed at the road level (to find a containing road part). This could be a separate query, or lane information could simply be ignored if not required in a particular context.

### Track Coordinates Query

FIG. 14A shows a track coordinates query 1400 at the SQE API 403. In this case, the query 1400 contains a point (x,y) but also a descriptor of a road part containing (x,y) (the interval S2 in this example). The latter is determined, in practice, by first running a containment query 1300 as per FIG. 13.

The SQE 402 uses the information in the track coordinates query 1400 to locate the corresponding entry in the road partition index 407 (step 1402), retrieves the road reference line function (step 1404) and computes the geometry of the road reference line for the road part in question (step 1406). In practice, this is done by finding the closest point to (x,y) on the road reference line within the specified road part S2 (the s-coordinate of (x,y) or its “ds” coordinate, which is then added to s2, the starting s-coordinate of the specified road part S2, to yield the s-coordinate). The s-coordinate of (x,y) is returned in a response 1401 along with its t-coordinate, namely the lateral offset between the point (x,y) and its s-coordinate. There is subtlety, in that the closest point to (x,y) on the road reference line might actually lie in another road part if (x,y) is close to one end of the specified road part. In this case, the response 1401 provides the closest point to (x,y) at the start or end of the lane section (at s2 or s3 for the road part S2), which is not the exact (s,t) coordinates. This may be explicit or implicit in the response 1401, and is left to the developer to resolve as needed—in some applications, the point at the beginning/end of the road/lane part may be sufficient in these circumstances. In other applications, where the precise coordinates are needed, the developer is free to code an additional road partition query to the API in those circumstances, on the closest adjacent road/lane part instead. In some applications, approximate (s,t) coordinates may be sufficient. If not, the developer can easily obtain the exact (s,t) coordinates by running a second track coordinate query on the same point (x,y) and the closest adjacent lane part to (x,y) (S1 or S3 in this case), and repeating as needed until the actual (s,t) coordinates are found. In an alternative implementation, those same steps could be performed automatically within the SQE 402 in those circumstances, in generating the response 1401 to the query 1400. In such implementation, the query 1400 on a specified road part (e.g. S2) always returns the actual (s,t) coordinates, even if those (s,t) coordinates lie in a different road part.

Note, the query 1400 is answered using the road partition index 407 directly (although, as noted, the road part may be found via an earlier containment query, that uses the box tree 450 in the first phase). Query to find closest point on lane center line

FIG. 14B shows a query 1450 to find the closest point on the centerline of a specified lane part, which is (Lane −2, road part S2) in this example. The principles are similar to FIG. 14B. The road partition index 407 is queried internally (step 1402) to obtain (step 1454) the functions required to compute the geometry of Lane −2 in road part S2. The functions are, in turn, used to compute the midline of the lane and compute therefrom the (s,t) coordinates of the point closest to (x,y) on the midline. As before, if (x,y) is close to one end of the road part, the closest point may lie in a different road part (which could belong to the same or a different lane section). As in FIG. 14A, this can, as needed, be resolved via further queries on the adjacent lane part, which may be external (and down to the developer using the API 403) or internal and automatic.

### Distance Query

FIG. 15A shows a distance query 1500 at the API 403, which contains a point (x,y). The distance query is provided as a tool to be used when a containment query returns a null result. A distance query may be type-specific or non-type specific in the same way as a containment query. The steps that are performed to respond to a non-type specific distance query assume that the point (x,y) is not contained in any side-lane; likewise, in responding to a type-specific distance query, it is assumed that (x,y) is not contained in a side-lane of the specified type. Therefore, the distance query 1500 should only be run when it has been verified, e.g. though an earlier containment query, that these assumption are valid (for a type-specific distance query, the point (x,y) may or may not be contained in a side-lane of some other types, and this does not need to be verified beforehand).

For a type-specific query, a filter is initially applied to the line segment trees 452a, 452b, to filter-out nodes other than those of the specified type. The result is filtered inner and outer boundary sub-trees, on which the query is then run (the same principle as type-specific containment queries).

The inner and outer lane-boundaries are indexed separately because if a predicate is used to filter out all of the lane parts that have a certain set of attributes (e.g. to consider only driveable lanes not injunctions) then the remaining lanes can end up separated by what amounts to a ‘void’ (where the rejected lanes are). That means that, in general, voids can appear in the interior of roads and so when measuring to the nearest side-lane one has to consider that the distance may be measured either to the inner boundary or the outer boundary of a lane (this is further exemplified in the description below that accompanies FIG. 15C).

When no predicate is used (and all side-lane are considered) it is usual that measurements would only ever be made to outer boundaries (see the description below accompanying FIG. 15B).

This involves making two indices that contain much the same data, but the associations are different and that is what the inner and outer boundary segment indices are providing. This duplication is favoured for its simplicity, rendering the code of the SQE 402 easier to maintain.

A response 1501 returns a descriptor of the closest side-lane to (x,y) of any type for a non-type-specific distance query (Lane −2 in road part S2 of Road M in this example). For a type-specific distance query, the response 1501 returns the closest side-lane of the type specified via one or more lane flags in the distance query 1500.

The closest side-lane is found using the inner and outer line segment trees 452a, 452b.

For each tree 452a, 452b, based on the parent bounding boxes, it is generally possible to locate the single lowest-level parent node whose bounding box (A4 in this case) contains the closest line segment to (x,y), or at least a small number of candidate parent nodes.

To do so, the system finds a candidate line-segment that satisfies all of the active predicate(s) and one then measures the distance from the query point to that line-segment. That value (and it associated references) is stored as a “best” distance. From that point on all line-segments that lie within bounding boxes that are further from the query point than the “best” distance can be discarded without further checks (this is how the acceleration is realised). For bounding boxes that are nearer that the “best” distance, all child bounding boxes are considered. When a leaf node (a node that actually contains a line-segment) that satisfies all of the active predicates is encountered the distance from the query point to the line-segment is measured and compared to the “best” distance. If it is smaller, it replaces the previous best distance, and so on. At the end of this process the nearest line-segment to the query point is that associated with the “best” distance. Such ‘divide and conquer algorithms’ are known per se, and are not described in further detail herein.

Having identified the (or each) lowest-level parent node, only its (or their) leaf node children need to be considered. Of those child nodes, the closest line segment in the tree provides the closest inner or outer lane boundary to (x,y) as applicable.

For a type-specific query, lanes other than the specified type are disregarded at the earliest opportunity.

FIG. 15B illustrates, by example, principles of a non-type specific distance query, on a point 1520 that has returned a null result on a non-type-specific containment query. This null result implies that (x,y) does not lie within any side-lane of the road or road network that was the subject of the containment query. This, in turn, means that only the outer lane boundaries need to be considered. The above steps can therefore be performed on the outer boundary tree 452b only, in order to identify the closest outer boundary line segment 1522 to the point 1520. The corresponding leaf node bundle, in turn, provides the lane ID of the closest lane (the lane having the outer boundary on which the closest line segment lies).

FIG. 15C illustrates, by example, principles of a type-specific distance query on a point 1524. The point 1524 does not lie in any side-lane of the specified type, and this should be verified before making the query. It may or may not be contained in another type of side-lane and this does not need to be verified before making the query. In the depicted example, the point 1524 lies in Lane 3, which is not of the specified type. Neighbouring lanes Lane 2 and Lane 4 are of the specified type.

In total, eight lanes (6, . . . , 1,−1,−2) are shown, with lane boundaries summarized in Table 6. In Table 6, bold font is used to denote a lane of the type specified in the query (matching the specified lane flags).

TABLE 6
Lane boundaries of FIG. 15C.

| | Inner boundary to | Outer boundary to |
|---|---|---|
| Lane boundary 1502 | None | Lane 6 |
| Lane boundary 1504 | Lane 6 | Lane 5 |
| Lane boundary 1506 | Lane 5 | Lane 4 |
| Lane boundary 1508 | Lane 4 | Lane 3 |
| Lane boundary 1510 | Lane 3 | Lane 2 |
| Lane boundary 1512 | Lane 2 | Lane 1 |
| Lane boundary 1514 | Lane 1 | None |
| (center line) | Lane −1 | |
| Lane boundary 1516 | Lane −2 | Lane −1 |
| Lane boundary 1518 | None | Lane −2 |

As discussed above, a line segment can appear in both the inner and outer boundary trees 452a, 452b. This would apply to the line segments on all of the lane boundaries shown in FIG. 15C except for the outer boundaries 1502, 1518 of Lanes 6 and −2 (which are not inner boundaries), and the centerline 1514 (not an outer boundary). For example, first and second line segments 1526, 1528 are depicted, which are the closest line segments to the point 1524 on boundaries 1508 and 1510 respectively.

In the inner boundary tree 452a, the first line segment 1526 is associated with Lane 3 (lying on its inner boundary), whereas in the outer boundary tree 452b, the same line segment 1526 is associated with Lane 2 (lying on its outer boundary). In the inner boundary tree 452a, the second line segment 1528 is associated with Lane 4 (lying on its inner boundary), whereas in the outer boundary tree it is associated with Lane 3 (lying on its outer boundary). Lane 3 (which happens to contain the point 1524) does not match the type specified in the query, and the first line segment 1526 will therefore be excluded in the search on the inner boundary tree 452a (as a consequence of its association with Lane 3 in the inner boundary tree 452a); that query will instead locate the second line segment 1528 as the closest line segment in the inner boundary tree 452a matching the specified lane type (as a consequence of its association with Lane 4 in the inner boundary tree 452a), and return the bundle for Lane 4. For the same reason, the second line segment 1528 will not be returned in the query on the outer boundary tree 452b (because of its association with non-matching Lane 3 in the outer boundary tree 452b), and that query will instead identify the first line segment 1526 as the closest matching line segment (because of its association with Lane 2, matching the specified lane type). Finally, it is simply a case of selecting the closest line segment out of the first line segment 1526 (as returned by the search on the outer boundary tree 452b) and the second line segment 1528 (as returned by the search on the inner boundary tree 452a).

Since one never wants to retrieve a center-lane part reference when looking up side-lane parts, the center lane itself is not indexed. That said, the line-segments that are supported by the lane-reference line (the road reference line offset by the lane-offset) are indexed in the inner side-lane boundary line segment index, where they are associated with both the inner left and the inner right side-lanes of a lane-section. However, those line-segments would only support a nearest query if they were exterior in the presence of some predicate (say one for which the inner left lane is filtered out whilst the inner right lane is left in place). In that case, the inner boundary of the most inner right side-lane is “exposed” and so must be considered when computing the nearest side-lane to another entity.

In the above examples, a distance query is answered using only the boundary indexes 252a, 252b. The road partition index 407 is not used at the point of query. The system simply returns the entity associated with the nearest line segment in the index. This is sufficient if one is happy with the approximate nature of the line-segments that have been inserted into the line segment indices.

A refinement of the above techniques returns the k-nearest neighbours based on the search of the line segment tree(s). A higher resolution test (a distance measurement) is then performed on each of those k-nearest neighbours to determine which of them is actually nearest. In this manner, a result is provided of accuracy higher than the line segment trees 452a, 452b.

### Applications

One application of the described techniques is to support a graphical scenario editor, in which a user can “drop” points on a road layout, and automatically generate paths through these points. The API 403 of the SQE 402 can be used to support the graphical interface, using the queries described above. For example, International Patent Application No. PCT/EP2021/064283, the entire contents of which is incorporated herein by reference, disclosed a graphical scenario editor tool for creating/editing scenarios for use in simulation. A user marks locations on a graphical representation of the road, which are used to generate a path automatically. The SQE 402 can be used to support such a tool via structured queries to the API 403 that are generated responsive to GUI inputs.

Another application is roundabout detection. Roundabouts may be identified by identifying one-way loops in graphs of roads, from the lane graph representation 700. An additional query mode to find any one way loops—or, more generally, isomorphic subgraphs of the lane graph 700—can be provided for this purpose. A slight ‘coarsening’ of the directed lane graph may be used to detect roundabouts in which only the road links are retained. The system looks specifically for loops in the directed road graph that begin in the connecting road of junctions and are solely composed of one-sided roads ( ) roads with only left or right lanes. All of the lanes in the connected loop that forms the roundabout itself will support traffic flow in the same compatible direction.

In a simulation context, the SQE 402 can support a scenario simulator, and in a run-time context it can support planning/predictions functions within the stack 100.

An alternative to the SQE 402 described above approach would be to run such queries on the static layer 412 (OpenDRIVE document) directly, via a lightweight view of the original document. However, the current OpenDRIVE format (v1.6.1) is too implicit a description of the road network to do this efficiently.

Instead, the geometric and topological indexes 409, 411 provide geometric and topological “views” of the document 414 (in the formal database sense).

The indexes 409, 411 are immutable, in that they are derived once from the static layer 414 and not varied.

References herein to components, functions, modules and the like, denote functional components of a computer system which may be implemented at the hardware level in various ways. A computer system comprises execution hardware which may be configured to execute the method/algorithmic steps disclosed herein and/or to implement a model trained using the present techniques. The term execution hardware encompasses any form/combination of hardware configured to execute the relevant method/algorithmic steps. The execution hardware may take the form of one or more processors, which may be programmable or non-programmable, or a combination of programmable and non-programmable hardware may be used. Examples of suitable programmable processors include general purpose processors based on an instruction set architecture, such as CPUs, GPUs/accelerator processors etc. Such general-purpose processors typically execute computer readable instructions held in memory coupled to or internal to the processor and carry out the relevant steps in accordance with those instructions. Other forms of programmable processors include field programmable gate arrays (FPGAs) having a circuit configuration programmable through circuit description code. Examples of non-programmable processors include application specific integrated circuits (ASICs). Code, instructions etc. may be stored as appropriate on transitory or non-transitory media (examples of the latter including solid state, magnetic and optical storage device(s) and the like). The subsystems 102-108 of the runtime stack FIG. 1A may be implemented in programmable or dedicated processor(s), or a combination of both, on-board a vehicle or in an off-board computer system in the context of testing and the like. The various components of FIG. 2, such as the simulator 202 and the test oracle 252 may be similarly implemented in programmable and/or dedicated hardware.

### REFERENCES

Reference is made hereinabove to the following, each of which is incorporated herein by reference in its entirety:
[1] ASAM OpenDRIVE V1.6.1 (and accompanying User Guide), Release Date 4 Mar. 2021 [available at https://www.asam.net/standards/detail/opendrive/]

1. A computer system configured to run queries on a static road layout, the computer system comprising:
at least one memory storing computer-readable instructions; and
at least one processor coupled to the at least one memory and configured to execute the computer readable instructions, which upon execution cause the at least one processor to:
store the static road layout in the at least one memory, the static road layout comprising a section of road having a set of multiple road attributes, each road attribute described throughout the section of road by a describing function that exhibits a change in form at one or more change points along the section of road, the change points of a first of the road attributes exhibiting longitudinal misalignment with respect to the change points of a second of the road attributes;
process the static road layout, and thereby partition the section of road into a sequence of road parts, each road part defined by a longitudinal coordinate interval, in which the describing function of every one of the road attributes has a form that is fixed throughout;
generate a road partition index having an entry for each road part, the entry indicating the form of the describing function of each road attribute as fixed throughout the longitudinal coordinate interval of that road part; and
implement a scenario query engine configured to receive a part query, and in response to the query: locate the entry in the road partition index for one of the road parts based on the part query, evaluate the describing function of at least one of the road attributes within the road part, and generate a part query response based on the evaluation of the describing function.

2. The computer system of claim 1, wherein a first of the change points in the first road attribute causes two longitudinally adjacent road parts to be created either end of the first change point, such that the describing function of the first road attribute has one form that is fixed throughout one of the two longitudinally adjacent road parts, and a different form that is fixed throughout the other of the two longitudinally adjacent road parts;
wherein the second road attribute has no change point that is longitudinally aligned with the first change point, causing the two longitudinally adjacent road parts to be created such that the describing function of the second road attribute has a single form throughout the two adjacent road parts;
wherein the entry for said one of the two longitudinally adjacent road parts contains an indication of said one form of the describing function of the first road attribute, wherein the entry for said other of the two longitudinally adjacent road parts contains an indication of said different form of the describing function of the first road attribute, and wherein the entries for the two longitudinally adjacent road parts contain duplicate indications of said single form of the describing function of the second road attribute as fixed throughout both of the longitudinally adjacent road parts.

3. The computer system according to claim 1, wherein each entry of the road partition index contains, for each road attribute, a reference to at least one memory location storing a single set of one or more function parameters that defines the form of the describing function of that road attribute as fixed throughout that road part.

4. The computer system of claim 2, wherein each entry of the road partition index contains, for each road attribute, a reference to at least one memory location storing a single set of one or more function parameters that defines the form of the describing function of that road attribute as fixed throughout that road part; and
wherein the entries for the two longitudinally adjacent road parts contain duplicate references to the same at least one memory location storing the single set of function parameters that define said single form of the describing function of the second road attribute.

5. The computer system of claim 1 wherein the part query comprises a descriptor of the road part to which it pertains, which is used to locate the entry for that road part by matching the descriptor to the road part.

6. The computer system of claim 5, wherein the descriptor in the part query comprises the longitudinal coordinate interval of the road part to which it pertains or a longitudinal coordinate within the longitudinal coordinate interval.

7. The computer system of claim 1, wherein the multiple road attributes comprise at least one road geometry attribute having a geometry described by its describing function

8. The computer system of claim 7, wherein the part query provides a set of world coordinates, and the scenario query engine is configured to evaluate the describing function of the at least one road geometry attribute in order to determine a corresponding set of road coordinates provided in the part query response.

9. (canceled)

10. The computer system of claim 1 wherein the section of road has multiple lanes, and the multiple road attributes comprise multiple lane attributes.

11. The computer system of claim 5, wherein the section of road has multiple lanes, and the multiple road attributes comprise multiple lane attributes; and
wherein the descriptor in the part query is a descriptor of a lane part that is defined by the road part and a lane identifier of one of the multiple lanes.

12. The computer system of claim 7, wherein the section of road has multiple lanes, and the multiple road attributes comprise multiple lane attributes; and
wherein the at least one road geometry attribute comprises at least one lane geometry attribute of the multiple lane attributes.

13. (canceled)

14. (canceled)

15. (canceled)

16. The computer system of claim 1, wherein the at least one processor is configured to:
implement a spatial indexing component configured to compute individual geometric elements of the static road layout, and create at least one spatial index of the individual geometric elements, wherein every individual geometric element is fully contained within a single road part;
wherein the scenario query engine is configured to receive a spatial query and use the spatial index to generate a spatial query response.

17. The computer system of claim 16, wherein the spatial indexing component is configured to use the road partition index to generate the spatial index, said part query being an internal part query for computing one or more of the individual geometric elements contained within the road part.

18. The computer system of claim 16, wherein the spatial index contains, for each individual geometric element, geometric data of the individual geometric element and an indication of the single road part for locating the entry for the single road part in the road partition index, and wherein the spatial query response comprises a descriptor of at least one road part satisfying the spatial query for locating the entry for that road part in the road partition index.

19. (canceled)

20. (canceled)

21. (canceled)

22. The computer system of claim 16, wherein the road section comprises multiple lanes, and each individual geometric element is a lane part, the lane part being one of the multiple lanes contained within the single road part or a portion of one of the multiple lanes contained with the single road part, the spatial index comprising a bounding box index storing, for each lane part, a lane part bounding box, a lane identifier, and an indication of the single road part for locating the entry for the single road part in the road partition index;
wherein the spatial query is a containment query providing a location, wherein the scenario query engine is configured to process the containment query by:
identifying any lane part whose lane part bounding box in the bounding box index contains the location;
using the indication of the single road part for any identified lane to locate the entry for that road part in the road partition index,
using the describing function for at least one of the road attributes to compute a lane geometry for the lane identifier, and
determining whether the provided location is contained within the lane geometry.

23. (canceled)

24. (canceled)

25. (canceled)

26. (canceled)

27. (canceled)

28. (canceled)

29. The computer system of claim 1 wherein the at least one road attribute whose describing function is evaluated in response to the query comprises a road geometry attribute having a geometry described by its describing function, the describing function evaluated to compute the geometry of the road geometry attribute.

30. The computer system of claim 29, wherein the describing function is evaluated to compute the geometry to a level of accuracy defined in the query.

31. The computer system of claim 3, wherein the at least one road attribute whose describing function is evaluated in response to the query comprises a road geometry attribute having a geometry described by its describing function, the describing function evaluated to compute the geometry of the road geometry attribute; and
wherein the describing function is evaluated using the function parameters accessed from the at least one memory location using the reference contained in the road partition index.

32. A non-transitory computer readable medium embodying computer program instructions, the computer program instructions configured so as, when executed on one or more hardware processors, to implement operations comprising:
storing the static road layout in computer storage, the static road layout comprising a section of road having a set of multiple road attributes, each road attribute described throughout the section of road by a describing function that exhibits a change in form at one or more change points along the section of road, the change points of a first of the road attributes exhibiting longitudinal misalignment with respect to the change points of a second of the road attributes;
processing the static road layout by a road partitioning component, and thereby partitioning the section of road into a sequence of road parts, each road part defined by a longitudinal coordinate interval, in which the describing function of every one of the road attributes has a form that is fixed throughout;
generating a road partition index having an entry for each road part by a road indexing component, the entry indicating the form of the describing function of each road attribute as fixed throughout the longitudinal coordinate interval of that road part; and
receiving a part query by a scenario query engine, and in response to the query;
locating the entry in the road partition index for one of the road parts based on the part query, evaluating the describing function of at least one of the road attributes within the road part, and generating a part query response based on the evaluation of the describing function.

33. A non-transitory computer readable medium embodying computer program instructions, the computer program instructions configured so as, when executed on one or more hardware processors, to implement operations comprising:
running queries on the static road layout using a road partition index of a static road layout, the static road layout comprising a section of road having a set of multiple road attributes, each road attribute described throughout the section of road by a describing function that exhibits a change in form at one or more change points along the section of road, the change points of a first of the road attributes exhibiting longitudinal misalignment with respect to the change points of a second of the road attributes, the road partition index comprising:
an entry for each road part of a sequence of road parts, each road part defined by a longitudinal coordinate interval, in which the describing function of every one of the road attributes has a form that is fixed throughout, the entry indicating the form of the describing function of each road attribute as fixed throughout the longitudinal coordinate interval of that road part.
